(19) United States
(12) Patent Application Publication
(10) Pub. No.: US 2012/0241250 A1
(43) Pub. Date: Sep. 27, 2012

(54) Aerial Work Platforms and Aerial Work Platform Assemblies Comprised of Polymerized Cycloolefin Monomers

(76) Inventors: George R. Eakin, Osborne, KS (US); Jason L. Moore, Pasadena, CA (US)

(21) Appl. No.: 13/430,608

(22) Filed: Mar. 26, 2012

Related U.S. Application Data
(60) Provisional application No. 61/467,785, filed on Mar. 25, 2011.

(51) Int. Cl. B66F 11/04

(52) U.S. Cl. 182/2.2; 182/222; 182/63.1

(57) ABSTRACT

An aerial work platform assembly includes: a) a platform shaft retaining assembly; b) a mounting bracket connected to the platform shaft retaining assembly; and c) a platform connected to the mounting bracket. The platform shaft retaining assembly includes two concentric apertures for installation of a pivot shaft therein; the mounting bracket having an upper gusset member and a center gusset member that are bonded together and that include horizontal portions to which the pivot shaft is bonded; upper and lower platform pins; a valve bracket; a platform bracket; and upper platform pins that provide for pivoting on a lower platform pin and tilting down of the platform thereby. At least one of the platform shaft retaining assembly, the mounting bracket, the platform, the upper and lower platform pins, and the valve bracket are molded from at least one monomer having at least one norbornene functionality, such as polydicyclopentadiene.

### RELATED APPLICATIONS

This application claims priority of U.S. Provisional Application No. 61/467,785 filed on Mar. 25, 2011. The entire content of this prior application is incorporated herein by reference.

### BACKGROUND OF THE INVENTION

Aerial Devices and Aerial Work Platforms and Aerial Work Platform Assemblies are known and are described in U.S. Pat. Nos. 2,954,092; 3,005,512; 3,022,854; 3,087,581; 3,139,948; 3,146,853; 3,159,240; 3,169,602; 3,233,700; 3,295,633; 3,404,751; 3,414,079; 3,554,319; 3,590,948; 3,605,941; 3,625,305; 4,047,593; 4,160,492; 4,334,594; 4,553,632; 4,763,755; 4,763,758; 4,883,145; 5,460,246; 5,722,505; 5,944,138; and 7,748,496, the contents of each of which are included herein by reference in their entirety. Aerial Work Platforms and Aerial Work Platform Assemblies are also known and are described in U.S. patent application Ser. Nos. 11/055,346; 12/284,572; and 12/761,836, the contents of each of which are included herein by reference in their entirety.

The present invention may be used with and relates generally to aerial devices, which devices may be stationary or mounted to vehicles including without limitation trucks, digger derricks, cranes or other mechanized mobile equipment. The present invention may be used with and relates generally to structural components of such aerial devices including without limitation aerial work platforms and aerial work platform assemblies, which are constructed from polymer materials molded from monomers having at least one norbornene functionality. The present invention may be used with and relates generally to structural components of such aerial devices including without limitation aerial work platforms and aerial work platform assemblies, which are constructed from polymer materials molded from polydicyclopentadiene. The present invention may be used with and relates generally to various aerial device constructions, including without limitation overcenter, non-overcenter, telescopic, and telescopic articulating.

Stationary aerial devices and vehicle mounted aerial devices have long been used for a variety of applications such as performing work on utility poles, trimming trees, maintaining street lights, and servicing overhead power and telephone lines. The aerial device normally includes a multiple-section boom, which can either be an articulating boom or a boom that is extensible and retractable in telescoping fashion. The end of the upper boom is equipped with a personnel carrying device, which is typically a platform, sometimes called a “bucket” or aerial work platform. The terms platform, aerial work platform, and bucket may be used interchangeably in this document. The aerial work platform assembly includes: the mounting brackets, platform, jib, the control assembly, control input mechanism and all other components at the end of the upper boom. This aerial work platform assembly is commonly referred to as the “boom tip.” More than one platform may be attached to the end of the upper boom, and a platform may be large enough to carry one or more workers. Supplemental load lifting devices may also be installed on the boom near the platform in order to provide the aerial device with material lifting capabilities, in addition to its personnel lifting feature. The load lifting device is typically an adjustable jib, a winch, or a combination of both.

Typically, an aerial device mounted to a vehicle broadly comprises a platform, which serves as a work station for the operator; a movable boom; a vehicular base, such as a truck; a control input mechanism; and a control assembly. The platform is operable to lift or otherwise carry at least one worker to the elevated work site, and is coupled with the boom at or near a distal end thereof. Because the platform may be used near highly-charged electrical lines or devices, the platform is typically electrically isolated from the ground through the insulated booms and vehicle base so as to provide secondary protection against damaging electrical discharge or electrocution of the worker or bystanders. One component in isolating the platform occupant from ground through the booms and vehicular base is a non-conductive platform liner, which provides some electrical isolation for the occupant's lower extremities, as long as the lower extremities are contained entirely within the liner and in contact with nothing other than the liner.

The booms are movable so as to elevate and otherwise position the platform where desired, and are coupled with the vehicular base at or near a base end of the lower boom, which is substantially opposite the distal end. The upper boom is constructed of an electrically non-conductive, or dielectric, material and provides secondary protection by preventing a path to ground through the booms and vehicular base. Commonly, in order to further electrically isolate the platform from electrical discharge via the boom and the vehicular base, an intermediate portion or section of the lower boom is constructed of or covered with an electrically non-conductive, or dielectric, material. The distal end of the boom or boom tip however, though electrically isolated from the vehicular platform, must incorporate structural material so as to have sufficient structural strength to support the platform and worker. This structural material is typically an electrically conductive metal, such as steel, with the steel, platform and control assembly being considered electrically connected. In addition to the boom assembly, various other parts at the end of boom are constructed from metals, such as steel or aluminum, and all components at the end of the boom must be considered electrically connected. The vehicular base is motorized and wheeled or otherwise adapted to quickly and efficiently travel to and from the work site. The vehicular base will either be in direct contact with an electrical ground, such as, for example, the Earth, or must be considered in direct or indirect contact therewith.

The control input mechanism allows the elevated worker to provide a control input to control, via the control assembly, movement of the boom and positioning of the platform. Commonly, the control assembly comprises one or more hydraulic control valves, one or more fluid conduits and a quantity of hydraulic fluid, to transmit the control input down the boom for implementation. The necessary conduit connections, however, prevent the control valves from being located inside the platform and its protective liner. Furthermore, as the control input mechanism must be in direct physical contact with the control assembly in order to actuate the valves in accordance with the control input, the control input mechanism without proper protective equipment must also be located outside the platform and protective liner. Thus, the worker may reach outside the protective liner to actuate the control input mechanism, thereby exposing him or herself to possible electrocution if they are working in the area of energized lines, contrary to federal safety regulations and employer safe practices. The control valves to which the control input mechanism is coupled are typically constructed of an electrically conductive material. Furthermore, the control valves may be located in close proximity to the aforementioned electrically conductive structural support material used to reinforce the distal end of the boom.

Thus, although the aforementioned dielectric boom portion does protect against electrical discharge via the boom and vehicular base, it does not protect against direct discharge via the electrically conductive structural material in the distal end of the boom, via the control valves, and via the control input mechanism. For example, a discharge path could be from an unprotected first conductor, to any component at the boom tip, to any other component at the boom tip, including the control input mechanism, to a worker not using rubber gloves, and to a second unprotected conductor. It will be appreciated that the dielectric boom portion provides no protection against this or similar discharge paths.

In order to minimize the risks of injury, the operator must always maintain safe clearances from electrical lines in accordance with applicable government regulations, such as those promulgated by the Occupational Safety and Health Agency (OSHA), and safe work practices adopted by the employer. Furthermore, if the possibility of electrical contact or proximity exists, operators must use proper protective equipment, which provides primary protection from electrical injury. The aerial device will not provide protection from contact with or in proximity to an electrically charged power line when the operator or the components at the boom tip are in contact with or in proximity to another power line, ground, or pole. If such contact or proximity occurs, all components at the boom tip, including the controls, may become energized. It should be understood that no invention will completely prevent electrical accidents. However, the present invention provides greater protection than existing designs against electrical injury that may be sustained by a worker whose behavior does not conform to government regulations and safe work practices.

As stated above, such aerial devices are conventionally used to perform work in proximity to electrical power lines, or in the construction or maintenance of electrical power lines, and it is quite common for work personnel to operate on the power lines while the power lines are elevated and carrying relatively high voltages. For this purpose, it is essential in the first instance that the platform and aerial work platform assembly be adequately strong to support the weight of a work person as well as the equipment, which they must use while in an elevated position. Also it is necessary that the platform in and of itself be relatively light in weight to reduce the load placed on the booms to a minimum. Additionally the platform should be of high dielectric strength in order to protect a person from danger in the event they should come into contact with a charged power line. Still further, it is necessary that the platform structure be impervious to moisture so as to prevent the conduction of electrical currents from the power lines to the workman in the event the platform should either come in contact with or approach closely a power line.

Such platforms are conventionally fabricated of resin or plastic, which is reinforced with glass thread or fiber. Such reinforced plastic has considerable strength to weight ratio; however, in order to provide adequate dielectric strength for the purpose of working on power lines, it is necessary that the wall thickness of this reinforced plastic be substantial. The resultant structure, in this instance, is so heavy that its utility for the intended purpose becomes impaired such that other means must be resorted to for providing dielectric strength.

Prior to the time of this invention, in providing a platform arrangement, which was of lightweight, strong construction and yet provides the necessary dielectric strength, the platform itself was fabricated of rigid plastic reinforced with glass fibers and used as the main personnel supporting structure and a platform-shaped polyethylene liner was removeably inserted thereinto. The resultant assembly provided the requisite dielectric strength while retaining the necessary characteristics of being relatively light in weight but nevertheless strong as a supporting structure. However the use of such a polyethylene liner is not entirely satisfactory inasmuch as the liner itself is relatively heavy, it must be easily removable from the outer shell, and furthermore must be removed and periodically tested for dielectric strength. The polyethylene liner also adds cost to the overall aerial work platform assembly. Polyethylene liners or protective liners comprising other non-conductive materials may be used with the aerial work platforms and aerial work platform assemblies of the present invention if so desired.

In view of these disadvantages of the prior art arrangements, it becomes desirable to provide a platform construction having the requisite characteristics of permanency, physical strength, lightweight, high dielectric strength, and moisture impermeability.

There is a need for an improved aerial work platform and aerial work platform assembly that may better protect the worker against electrical discharge when regulations and safe practices are not followed. While various non-metals, such as rubber, plastic, and polymer materials might satisfy the dielectric requirement of the components in such an improved system, most of those materials are not suitable. The aerial work platform and aerial work platform assembly components must be structurally rigid and durable, but cannot be overly bulky and cumbersome to manipulate. Thus, there remains a need for an aerial work platform and aerial work platform assembly that maximizes the number of parts, which are lightweight, structurally rigid, durable, and substantially nonconductive, in addition to being more cost effective than the construction of prior art aerial work platforms and aerial work platform assemblies. From the description that follows, it will be seen that the present invention accomplishes these objectives.

### SUMMARY OF THE INVENTION

Conventional thermoset materials, including without limitation epoxy, epoxy vinyl ester, polyester, vinyl ester, silicone, phenolic and polyurethane, have relatively high dielectric losses and high dielectric constants, which are not desirable for aerial devices including without limitation aerial work platforms and aerial work platform assemblies.

As noted above, platforms constructed from such conventional thermoset materials requires the use of a non-conductive platform liner, which provides some electrical isolation for the occupant's lower extremities, as long as the lower extremities are contained entirely within the liner and in contact with nothing other than the liner.

In addition, as noted above, aerial work platforms and aerial work platform assemblies constructed from such conventional thermoset materials requires the use of fiber reinforcement to provide the necessary structural strength, as such thermoset materials without fiber reinforcement are not able to meet the necessary requirements for structural strength. Fiber reinforced aerial work platforms and aerial work platform assemblies are also difficult to manufacture, requiring significant amount of manual labor in laying up the fiber reinforcement and applying the resin matrix. The use of fiber reinforcement also adds a significant amount of weight to the aerial work platform and aerial work platform assembly, which creates additional stresses on the aerial device including but not limited to the boom. The use of fiber reinforcement also adds a significant amount of cost to the aerial work platform and aerial work platform assembly.

Aerial work platforms and aerial work platform assemblies made of an improved material and made by a more efficient method is desired.

Aerial work platforms made of an improved material having sufficient dielectric performance so as to eliminate the need to use a non-conductive platform liner is desired.

Aerial work platforms and aerial work platform assemblies made of an improved material having sufficient strength so as to eliminate the need to use fiber reinforcement to provide the necessary structural strength is desired.

Aerial work platforms and aerial work platform assemblies made of an improved material that is lighter in weight is desired.

Aerial work platforms and aerial work platform assemblies made of an improved material that is impervious to moisture and changes in temperature and weather is desired.

It is also desirable to have an aerial work platform and aerial work platform assembly made of an improved material so that the need for periodic testing of the dielectric strength may be reduced in frequency or no longer necessary.

Prior to this invention, aerial devices, including but not limited to aerial work platforms and aerial work platform assemblies, have not been constructed from materials comprising polymer materials molded from monomers having at least one norbornene functionality. Prior to this invention, aerial devices, including but not limited to aerial work platforms and aerial work platform assemblies, have not been constructed from materials comprising polydicyclopentadiene.

Polydicyclopentadiene (“pDCPD”) is a polyolefinic thermoset material that has outstanding dielectric characteristics: low dielectric constant, low dielectric loss, and high breakdown strength that are similar to the thermoplastic polypropylene but higher thermal stability similar to the thermoset epoxy. pDCPD is formed by polymerizing dicyclopentadiene monomer. Dicyclopentadiene is a polycyclic olefin comprising a norbornene functional group. In addition, pDCPD also has great mechanical strength and fracture toughness. Due to the extremely low viscosity of the dicyclopentadiene monomer, pDCPD is easy to process and has flexibility for use in a large range of processing methods and techniques including without limitation reaction injection molding (RIM); resin transfer molding (RTM), rotational molding, casting, filament winding, centrifugal casting, hand lay-up, and container mixing. The dielectric performance of pDCPD can also be further enhanced by the addition of additives including without limitation fumed silica and other fillers or reinforcing materials. For example, it has been reported, in U.S. Patent Application Publication Number: 2010/0148903, the contents of which are incorporated herein by reference, and in Yin et al., “Dielectric Properties of Polydicyclopentadiene and Polydicyclopentadiene-silica Nanocomposite,” Electrical Insulation (ISEI), Conference Record of the 2010 IEEE International Symposium, the contents of which are incorporated herein by reference, that the corona resistance of pDCPD can be further enhanced by the addition of nanosilica to pDCPD.

It is therefore an objective of this invention to provide improved aerial work platforms and aerial work platform assemblies comprising polymers molded from monomers having at least one norbornene functionality.

It is therefore an objective of this invention to provide improved aerial work platforms and aerial work platform assemblies comprising polydicyclopentadiene.

Another objective of this invention is to provide an aerial work platform structure capable of being interchanged and attached to the end of the upper boom or used with any aerial platform work assembly.

Another objective of this invention is to provide an aerial work platform and aerial work platform assembly capable of being molded into any geometric shape or size with uniform part thickness or non-uniform part thickness.

Another objective of this invention is to form an aerial work platform and aerial work platform assembly to produce a suitably stiff and rigid structure sufficient to support work personnel for an extended period of time in any type of weather conditions.

Another objective of this invention is to provide an aerial work platform and aerial work platform assembly capable of resisting impact and other forces.

Another objective of this invention is to provide an aerial work platform and aerial work platform assembly that possesses improved dielectric characteristics including but not limited to low dielectric constant, low dielectric loss, and high breakdown strength.

Another objective of this invention is to provide an aerial work platform and aerial work platform assembly that is electrically non-conductive.

Another objective of this invention is to provide an aerial work platform and aerial work platform assembly in which the surface of the aerial work platform and aerial work platform assembly is coated with (i) a primer; or (ii) a primer and paint top coat.

Another objective of this invention is to provide an aerial work platform and aerial work platform assembly that may be used with vehicles as part of a mobile aerial device.

Another objective of this invention is to provide an aerial work platform and aerial work platform assembly that may be used as part of a non-mobile aerial device or stationary structure or stationary aerial device.

Another objective of this invention is to provide an aerial work platform and aerial work platform assembly, which is relatively inexpensive to manufacture and lightweight for easy handling; for reduction in fuel consumption; for reduction in fuel costs; and to reduce load forces on booms and other parts of the aerial device.

Another objective of this invention is to provide an aerial work platform and aerial work platform assembly and a method of making an aerial work platform and aerial work platform assembly that uses green chemistry methods or materials that are more environmentally friendly.

Another objective of this invention is to provide an enclosure apparatus for the aerial work platform. The aerial work platform enclosure is designed to be easily installed upon an enclosed aerial work platform. The enclosure protects the worker from environmental elements without reducing visibility out of the platform. The enclosure is manufactured from a material comprising a polymer comprising monomers having at least one norbornene functionality. Aerial platform enclosure apparatuses are known and have been described in U.S. Pat. No. 5,611,410, the contents of which are included herein by reference in their entirety, including the contents of all cited references, including without limitation U.S. patent documents, foreign patent documents, and other publications.

Another objective of this invention is to provide an aerial work platform and aerial work platform assembly and a method of making the same molded from a polymer comprising polydicyclopentadiene (“pDCPD”).

Another objective of this invention is to provide an aerial work platform and aerial work platform assembly and a method of making the same molded from a polymer comprising monomers having at least one norbornene functionality.

Another objective of this invention is to provide an aerial work platform and aerial work platform assembly and a method of making the same molded from a resin comprising polydicyclopentadiene (“pDCPD”).

Another objective of this invention is to provide an aerial work platform and aerial work platform assembly and a method of making the same molded from a resin having at least one norbornene functionality.

Another objective of this invention is to provide an aerial work platform and aerial work platform assembly and a method of making the same wherein any functional accessories, including without limitation, steps, attachment fittings, pins, shafts, brackets, shafts, or ribs comprises a polymer comprising monomers having at least one norbornene functionality.

Another objective of this invention is to provide an aerial work platform and aerial work platform assembly and a method of making the same wherein any functional accessories, including without limitation, steps, attachment fittings, pins, shafts, brackets, shafts, or ribs comprise polydicyclopentadiene.

Another object of this invention is to provide an aerial work platform and aerial work platform assembly, which overcomes the weight and temperature change problems of metal, plastic, polymeric, and composite materials in aerial devices that have been previously reported. The aerial work platform of the present invention comprises a polymer comprising monomers having at least one norbornene functionality. Polymers formed using monomers having at least one norbornene functionality provide a light-weight and strong product that can withstand various stresses associated with material loads and changes in temperature and weather.

Another objective of the present invention is to provide an aerial work platform and aerial work platform assembly, which uses electrically non-conductive composite materials comprising a polymer comprising monomers having at least one norbornene functionality.

Another objective of the present invention is to provide an aerial work platform and aerial work platform assembly, which replaces a maximum of metal parts in the assembly to reduce or eliminate electrical conductivity.

Another objective of the present invention is to provide an aerial work platform and aerial work platform assembly, which is lighter in weight than conventional designs.

Another objective of the present invention is to provide and aerial work platform and aerial work platform assembly that does not require the use of fiber reinforcement as part of the resin matrix or for use with the resin matrix.

Another object of the present invention is to provide an aerial work platform and aerial work platform assembly, which maintains the desired structural integrity and reduces manufacturing and maintenance costs.

Accordingly, an aerial work platform assembly is provided, comprising a platform shaft retaining assembly; a mounting bracket connected to the platform shaft retaining assembly; and a platform connected to the mounting bracket; wherein the platform shaft retaining assembly, mounting bracket, and platform are constructed from the same or differing composite materials comprising an optional fiber reinforced resin. Optionally, the fiber reinforced resin includes a preform fiber reinforcement having a conformable three-dimensional weave, and the resin is a dielectric resin selected from monomers having at least one norbornene functionality.

Accordingly, an aerial work platform assembly is provided, comprising a platform shaft retaining assembly; a mounting bracket connected to the platform shaft retaining assembly; and a platform connected to the mounting bracket; wherein the platform shaft retaining assembly, mounting bracket, and platform are constructed from the same or differing materials comprising monomers having at least one norbornene functionality. Optionally, the resin is a dielectric resin selected from monomers having at least one norbornene functionality.

The present invention is directed to an aerial work platform and aerial work platform assembly comprised of bulk polymerized monomers having norbornene functionality. These monomers may be polymerized within a closed mold, which defines the shape of the aerial work platform and components of the aerial work platform assembly. This manufacturing method makes use of fiber reinforcement as an option. Some embodiments may not utilize fiber reinforcement for the reasons discussed above including but not limited to weight reduction and cost reduction.

The present invention may also be applied to components of the control input mechanism or control input assembly as disclosed in U.S. Pat. No. 7,416,053, the contents of which are included herein by reference in their entirety.

The bulk polymerized norbornene functional monomers provide excellent chemical resistance and the lifetime of the aerial work platform and aerial work platform assembly will exceed that of fiberglass reinforced polyester aerial work platforms and aerial work platform assemblies made from known composite materials. In addition, the aerial work platforms of the present invention need not be relined with a polyethylene liner or equivalent non-conductive thermoplastic material. It has been found that this molding/bulk polymerization procedure may also provide a one piece integrated structure with all the essential features of an aerial work platform or components of the aerial work platform assembly. The molding procedures referenced herein may be used to produce the aerial work platforms and aerial work platform assemblies with a number of features to be integrated into the one piece structure including without limitation hinges, structural reinforcement members, attachment fixtures, attachment fittings, attachment fittings, pins, shafts, brackets, shafts, or ribs and steps. The bulk polymerized norbornene functional monomers are also well suited to accept additives such as flame retardants, fillers, structural reinforcement, impact modifiers, antioxidants, pigments, dyes, etc. providing more versatile covers. The aerial work platforms and aerial work platform assemblies provided by this invention are also repairable and can be cut or machined to provide desired elements including without limitation hinges, steps, structural reinforcement members, and other methods of attaching said aerial work platforms and aerial work platform assemblies to other pieces of equipment including but not limited to booms.

Aerial work platforms and aerial work platform assemblies of this invention may have uniform thickness throughout the molded part or may have various thickness at different locations of the molded part.

The molding methods of this invention may allow for the manufacture of aerial work platforms and aerial work platform assemblies of any configuration, weight, size, and geometric shape. Geometric shapes include without limitation round, circular, square, rectangular, and polygonal. Aerial work platforms and aerial work platform assemblies for essentially any application can be produced using the present invention.

The aerial work platforms and aerial work platform assemblies of the present invention allow for the integration of these features in the structure but most important this molded construction allows for the manufacture of aerial work platforms, which do not require reinforcement fibers. Adequate cell wall thickness can be provided so that fiber reinforcement is not required to provide strength, and the method of manufacture does not necessitate the use of fiber reinforcement. However, if desired, fiber reinforcement can be positioned in the mold prior to fill, provided the fiber reinforcement does not interfere with the bulk polymerization of the norbornene functional monomers. Optionally fiber reinforcement can also be suspended or contained in the resin, and the combined resin matrix containing resin and fiber can be used to fill a mold to provide a molded article or molded part.

The present invention may use metathesis chemistry to form the molded aerial work platforms and aerial work platform assemblies. Metathesis chemistry is recognized among scientists and those generally skilled in the art of chemistry and polymer science as green chemistry. Green chemistry is not a particular set of technologies, but rather an emphasis on the design of chemical products and processes. Sometimes, green chemistry takes place at the molecular level to reduce or eliminate the use and generation of hazardous substances. This approach offers environmentally beneficial alternatives to more hazardous chemicals and processes, and thus promotes pollution prevention. Green chemistry can lead to dramatic changes in how we interact with chemicals on a daily basis as in the case of the 2005 Nobel Prize in Chemistry for the development of the metathesis method in organic synthesis and advanced polymer materials. In metathesis reactions, double bonds are broken and made between carbon atoms in ways that cause atom groups to change places. This happens with the assistance of special catalysts, which are referenced herein including without limitation catalysts containing ruthenium, molybdenum, and tungsten. Metathesis chemistry is used daily in the chemical industry, mainly in the development of pharmaceuticals and of advanced plastic materials. Thanks to the Laureates' contributions and the contributions of their co-workers, synthesis and monomer polymerization methods have been developed that are
more efficient (fewer reaction steps, fewer resources required, less wastage),
simpler to use (stable in air, at normal temperatures and pressures), and
environmentally friendlier (non-injurious solvents, less hazardous waste products).

This represents a great step forward for green chemistry, reducing potentially hazardous waste through smarter production. Metathesis is an example of how important basic science has been applied for the benefit of man, society and the environment.

The use of monomers containing at least one norbornene functionality is an improvement over resins currently used to mold aerial work platforms and aerial platform assemblies including but not limited to polyester resins and vinyl ester resins, which may contain various amounts of hazardous and harmful chemicals including but not limited to styrene. Styrene, a component in conventional polyester resins and vinyl ester resin, is currently being evaluated by the US Department of Health and Human Services National Toxicology Program, which has proposed to list styrene as a “reasonably anticipated” human carcinogen in the upcoming 12th Edition of the Report on Carcinogens.

The aerial work platforms and aerial work platform assemblies of the present invention are comprised of a bulk polymerized monomer having norbornene functionality. These monomers are sufficiently low in viscosity so that molds of any size including large molds can be easily filled and various molding methods can be utilized. The gel time (time at exotherm) of the reactive formulation with these monomers can be controlled to allow for slow fill of the mold under laminar flow at a rate of 2-8 lb per second or higher using multiple mix heads. Gel times in excess of 5-30 minutes are easily accomplished at temperatures of about 30° C. It is recommended that the mold not be filled under turbulent flow so that bubbles do not form, which causes voids in the finished part. It may also be necessary that the formulation be degassed to avoid the formation of bubbles during molding. Molding is generally accomplished with no back pressure or minimal internal mold pressure (a pressure of less than 10 psi), which allows gases within the formulation to expand and coalesce.

Bulk polymerization of the norbornene functional monomers is initiated at a relatively low temperature and the exotherm is relatively short, allowing for the use of plastic molds in manufacturing the aerial work platforms and aerial work platform assemblies of this invention. The plastic molds are less costly than metal molds making the molding of small numbers of aerial work platforms and aerial work platform assemblies economically feasible. Aerial work platforms and aerial work platform assemblies of the present invention can be molded using molds constructed of essentially any material, including without limitation epoxy, cast aluminum, machined aluminum, nickel shell, cast kirksite, machined steel, wood, polyester, vinyl ester, polydicyclopentadiene, sheet metal, polyurethane, glass, fiber reinforced polyester, filled polydicyclopentadiene, reinforced polydicyclopentadiene, fiber reinforced epoxy, and fiber reinforced vinyl ester.

In utilizing the reactive formulations it may be useful to purge the mold with nitrogen or argon to avoid contamination of the catalyst therein.

In addition to the processing advantages in providing aerial work platforms and aerial work platform assemblies comprised of bulk polymerized norbornene functional monomer there are advantages in utility as well. The aerial work platforms and aerial work platform assemblies of this invention show good (i) dimensional stability; (ii) chemical resistance; (iii) strength; (iv) mechanical properties; (v) impact properties over a wide range of temperatures; (vi) tensile properties; (vii) flexural properties; (viii) thermal properties including without limitation heat distortion temperature and glass transition temperature; (ix) hardness; (x) coefficient of linear thermal expansion; (xi) uv resistance; (xii) oxidative resistance; and (xi) physical properties. Formulations of this invention that are comprised of monomers having at least one norbornene functionality can be custom tailored to meet a wide range of performance requirements.

The monomers having norbornene functionality that may be polymerized in bulk are characterized by the presence of at least one norbornene group identified by the formula below, which can be substituted or unsubstituted. This invention contemplates preparation of homopolymers, copolymers, and terpolymers comprising dicyclopentadiene with monomers such as substituted norbornenes, including without limitation, methylnorbornene, ethylidene norbornenone, hexyl norbornene, functionalized norbornenes, trimers and tetramers and higher order oligomers of cyclopentadiene and methyltetracyclododecene. To accomplish bulk polymerization of these monomers within a mold, a suitable metathesis catalyst system may be used.

One type of metathesis catalyst system comprises a catalyst and cocatalyst. Each component can be dissolved in separate streams of the monomer and mixed prior to transfer into the mold cavity. Suitable catalysts of this type include molybdenum and tungsten compound catalysts such as organoammonium molybdates and organoammonium tungstates defined by the formulae below.

[R²₄N]_{(2y-6x)}M_{xOy},[R³₃NH]_{(2y-6x)}MₓO_{y}

Where O represents oxygen; M represents either molybdenum or tungsten; x and y represent the number of M and O atoms in the molecule based on a valence of +6 for molybdenum, +6 for tungsten and −2 for oxygen; and the R² and R³ radicals can be the same or different and are selected from hydrogen, alkyl and alkylene groups each containing from 1-20 carbon atoms and cycloaliphatic groups each containing from 5-16 carbon atoms. All of the R² and R³ radicals may not be hydrogens.

Specific examples of suitable organoammonium molybdates and organoammonium tungstates include tridodecylammonium molybdates and tungstates, methyltricaprilammonium molybdates and tungstates, tri(tridecyl)ammoniummolybddates and tungstates and trioctylammonium molybdates and tungstates. From 0.1 to 10 mol of catalyst are used per mole of total monomer. The molar ratio of catalyst to cocatalyst can vary from 200:1 to 1:10.

The cocatalyst comprises an alkyl aluminum or alkyl aluminum halide reacted with an alcohol so as to inhibit the reducing power of the cocatalyst. The reaction is rapid and results in the evolution of volatile hydrocarbons such as ethane, if diethyl aluminum is the cocatalyst. Specific examples of alkylaluminum compounds include ethylaluminum dichloride, diethylaluminum monochloride, ethylaluminum sesquichloride, diethylaluminum iodide, ethylaluminum diiodide, ethylaluminumdichloride and the like.

In providing long gel times for the norbornene functional monomers, it is known to react these alkylaluminum compounds with branched or hindered alcohols and to use combinations of such alcohols with unhindered alcohols. The use of compounds containing an acetylene moiety including without limitation 4-octyne or phenylacetylene may also be used to control the reactivity of the catalysts thereby providing extended gel times. The hindered alcohols include tertiary alcohols, secondary hindered alcohols and primary hindered alcohols. When such alcohols are combined with unhindered alcohols the temperature necessary to initiate gel in the reactive formulation is reduced. Specific examples of hindered secondary alcohols include 2,4-dimethyl-3-pentanol, 3,5-dimethyl-4-heptanol and 2,4-diethyl-3-hexanol and the like. Specific examples of hindered primary alcohols include neopentyl alcohol, 2,2-dimethyl-1-butanol, 2,2-diethyl-1-butanol and the like. Specific examples of suitable tertiary alcohols include t-butanol, t-amylalcohol, 3-ethyl-3-pentanol and the like.

Primary alcohols and secondary alcohols, which can be used in combination with the above hindered alcohols include 2-methyl-1-propanol, 2-ethyl-1-butanol and propanol. The hindered alcohols are used in a ratio of about 60:40 hindered versus unhindered or 2,4-dimethyl-3-pentanol is used with propanol in such as ratio. The amount of alcohol reacted with the aluminum compound is also indicative of the reducing power of the cocatalyst and at a ratio of from 1:1 to 1.25:1 total alcohol to aluminum compound is used. Where the cocatalyst does not contain any halide and activator is used to supply halide to the system. This halometal activator makes the system more reactive and tends to shorten the pot life. Suitable activators include chlorosilanes such as dimethymonochlorosilane, dimethyldichlorosilane, tetrachlorosilane and the like without limitation. The amount of activator used falls in the range of 0.05 to 10 millimole per mol of norbornene functional monomer and at low levels are used to prevent localized exotherms.

Reaction injection molding (RIM) and resin transfer molding (RTM) are forms of bulk polymerization, which may occur in a closed mold. RIM and RTM differ from thermoplastic injection molding in a number of important respects. Thermoplastic injection molding is conducted at pressures of about 10,000 to 20,000 psi in the mold cavity by melting a solid resin and conveying it into a mold maintained at a temperature below the glass transition temperature of the polymer and the molten resin is typically tat a temperature of about 150° C. to 350° C. The viscosity of the molten resin is generally in the range of 50,000 to 1,000,000 cps. In thermoplastic injection molding solidification occurs in about 10-90 seconds, depending on the size of the part. No chemical reaction takes place in the mold. In RIM and RTM processes the viscosity of the materials fed to the mold may be about 50-3,000 cps or from 100 to 1,500 cps at temperatures varying from room temperature to 80° C. At least one component in the RIM or RTM formulation is a monomer that is polymerized to a polymer in the mold. The primary distinction between injection molding and RIM/RTM resides in the fact that in the RIM and RTM processes a chemical reaction takes place to transform a monomer to a polymeric state.

While most RIM and RTM procedures have resulted in good molding with norbornene functional monomers, difficulties have been experienced when molding extremely large parts or parts having nonuniform thickness. Since the formulation injected into the mold reacts exothermically the heat generated from a large part can cause a fire under the right conditions. Therefore formulations with low and/or short exotherm may be desired. In addition when molding large parts such as those of the present invention delayed gel times may be used so the system does not react before the mold is filled. A gel time and time to exotherm in excess of two minutes at 40° C. may be used in an excess of 10 minutes at temperatures of about 40° C. Formulations of the present invention can be custom tailored to adjust for a wide range of gel times, gel temperatures, peak exotherm temperatures, and peak exotherm times.

When forming parts with such a slow reactive formulation having a delayed gel time it may be desirable to degas the monomer formulations so that any gas bubbles present may coalesce in the mold prior to the initiation of gelation. These gas bubbles may cause surface defects in the molded article. Degassing the monomer formulations just prior to mixing and injection into the mold may be desired. The level of dissolved gas in the reaction formulation can be characterized by the head space ratio parameter described below.

Commercially available DCPD resin formulations that may be used in this invention include without limitation Metton®, Telene®, Prometa®, Metathene® and Rutene®.

For the purposes of this invention monomers containing at least one norbornene-type functionality may be polymerized through the following mechanisms including without limitation ring-opening metathesis polymerization (ROMP), cationic polymerization, radical polymerization, vinyl polymerization, and addition polymerization.

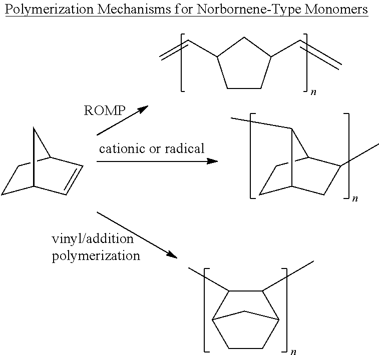

For the purposes of this invention catalyst complexes suitable for polymerizing monomers containing at least one norbornene-type functionality include without limitation ruthenium, osmium, iron, nickel, platinum, palladium, tungsten, cobalt, chromium, titanium, zirconium, iridium, rhodium, silver, gold, or molybdenum.

For the purposes of this invention ruthenium catalyst complexes suitable for polymerizing monomers containing at least one norbornene-type functionality include without limitation catalysts commonly known by the following names: Grubbs First Generation Catalyst, Grubbs Second Generation Catalyst, Hoveyda-Grubbs First Generation Catalyst, Hoveyda-Grubbs Second Generation Catalyst, Piers First Generation Catalyst, and Piers Second Generation Catalysts.

For the purposes of this invention ruthenium or osmium catalyst complexes suitable for polymerizing monomers containing at least one norbornene functionality include without limitation catalysts as described in U.S. Pat. No. 6,610,626 the contents of which is included herein by reference in its entirety including the contents of all cited references, including without limitation U.S. Patent Documents, Foreign Patent Documents, and other publications.

For the purposes of this invention ruthenium or osmium catalyst complexes suitable for polymerizing monomers containing at least one norbornene functionality include without limitation catalysts as described in the following: Chem. Eur. J. 2001, 7, 4811; Eur. J. Org. Chem., 2008, 1625; Chem. Commun. 2008, 2726; PCT publication WO07010453A2; PCT publication WO00/15339; Chem. Eur. J. 2007, 13, 8029; Eur. J. Chem. 2008, 432; PCT publication WO2003062253; PCT publication WO2008034552A1.

For the purposes of this invention ruthenium catalyst complexes suitable for polymerizing monomers containing at least one norbornene functionality include without limitation catalysts identified by the following Chemical Abstract Numbers (CAS #): [250220-36-1]; [894423-99-5]; [536724-67-1]; [1031262-76-6]; [934538-04-2]; [934538-12-2]; and [1031262-71-1].

For the purposes of this invention ruthenium catalyst complexes suitable for polymerizing monomers containing at least one norbornene functionality include without limitation catalysts identified by the following Chemical Abstract Numbers (CAS #): [172222-30-9]; [246047-72-3]; [203714-71-0]; [301224-40-8]; [927429-61-6]; [802912-44-3]; [927429-60-5]; [194659-03-9]; [253688-91-4]; [900169-53-1]; [1020085-61-3]; [832146-68-6]; [635679-24-2]; and [373640-75-6].

For the purposes of this invention, molybdenum based catalysts suitable for polymerizing norbornene-type monomers are described in U.S. Pat. Nos. 4,406,839; 4,262,103; 4,217,292; 4,138,448; 5,438,093; 5,066,740; 4,943,621; 4,923,939; 4,426,502; 4,418,179; 4,418,178; 4,380,617; 4,355,148; 4,324,717; 4,320,239; 4,310,637; 4,178,424; 4,168,282; 4,136,249; 4,110,528; 4,069,376 4,701,510; 4,906,797; 4,910,077; 5,087,343; 5,155,188; and RE34,638 the contents of each of which are included herein by reference in their entirety including the contents of all cited references, including without limitation U.S. Patent Documents, Foreign Patent Documents, and other publications.

For the purposes of this invention, catalysts suitable for polymerizing norbornene-type monomers by an addition polymerization mechanism or cationic polymerization mechanism are described in U.S. Pat. Nos. 6,350,832; 6,265,506; 6,197,984; 5,741,869; 5,677,405; 5,571,881; 5,569,730; 5,468,819; 4,948,856; 6,677,175; 7,087,691; 7,101,654; 7,378,456; 7,524,594; 7,662,996; and 7,759,439, the contents of each of which are included herein by reference in their entirety including the contents of all cited references, including without limitation U.S. Patent Documents, Foreign Patent Documents, and other publications.

In general, methods for solution and mass/bulk-polymerization techniques for the production of elastomeric, thermoplastic, or thermoset polymer items, parts or articles are known in the art. However, few if any describe using one or more reactant streams to form a reactive monomer mixture or composition, where if one reactant stream is used that reactant stream must contain at least one norbornene-type monomer and may contain at least one ruthenium or osmium or molybdenum or tungsten catalyst and may contain one or more additional system components. If more than one reactant stream is used at least one of the reactant streams must contain at least one norbornene-type monomer, at least one of the reactant streams may contain at least one ruthenium or osmium or molybdenum or tungsten catalyst and one or more of the reactant streams may contain one or more additional system components. Methods for extending the pot life suitable for use with this invention are known and are described in U.S. Pat. No. 5,939,504, which is included herein by reference in its entirety including the contents of all cited references, including without limitation U.S. Patent Documents, Foreign Patent Documents, and other publications. Pot life can be controlled using a variety of methods, but either through ligand manipulation, the addition of chemical additives, compounds or reagents, or by thermal methods.

Broadly stated, the invention involves using or combining one or more reactant streams to form a reactive monomer mixture or composition, which may be processed to form an elastomeric, thermoplastic, or thermoset polymer in the form of an aerial work platform or aerial work platform assembly or components thereof using one or more of the processing methods or techniques described and listed in this document. If one reactant stream is used that reactant stream must contain at least one norbornene-type monomer and may contain at least one ruthenium or osmium or molybdenum or tungsten catalyst and may contain one or more additional system components. If more than one reactant stream is used at least one of the reactant streams must contain at least one norbornene-type monomer, at least one of the reactant streams may contain at least one ruthenium or osmium or molybdenum or tungsten catalyst and one or more of the reactant streams may contain one or more additional system components. A system component can be a rate modifying component, a thermally deprotected NHC—X—Y species, solvents, organic liquids, inorganic liquids, blowing agents, fillers, fibers, pigments, dyes, lubricants, antioxidants, antiozonants, UV absorbing agents, UV stabilizing agents, crosslinking agents, odor absorbing or masking agents, flame retardants, light stabilizers, plasticizers, foaming agents, electromagnetic radiation absorbing materials, electromagnetic radiation reflecting materials, electromagnetic radiation emitting materials, electromagnetic radiation conducting materials, physical bonding agents, mechanical bonding agents, chemical bonding agents, thermal or electrical conducting materials or agents, thermal or electrical insulating materials or agents, whiskers for surface smoothing, radioactive absorbing materials, radioactive emitting materials, radioactive reflecting materials, sacrificial materials or additives for corrosive applications or environments, nano-sized fillers or reinforcements for making nanocomposite polymer materials, tougheners, reinforcing agents or materials, impact and polymeric modifiers and viscosifiers.

### Polymer Processing Methods and Techniques

The definitions provided herein as part of the invention are for use with the invention and may or may not be the same or different from other definitions for processing methods having the same name.

1. Rotational Molding: A processing method where one or more reactive streams are used or combined and conveyed into a heated or unheated mold that can be rotated about one or more axes turning at the same or different speeds. The rotation of the mold distributes the reactive monomer mixture inside the mold causing it to stick to and coat the walls of the mold allowing for the formation of seamless and stress-free hollow polymer parts of various sizes. The mold may be open or closed during the molding process. This processing method may or may not require the use of pressure during the molding process.

2. Cell Casting: A processing method where one or more reactive streams are used or combined and conveyed between two heated or unheated parallel plates or sheets where the reactive monomer mixture is allowed to polymerize. The two parallel plates are separated by a gasket, spacer, or seal, which is sandwiched between them, to form a compartment or cell to contain the reactive monomer mixture during the molding process. The thickness of the gasket, spacer, or seal is used to establish the thickness of the molded polymer part.

3. Dip Casting: A processing method where an item or article is dipped one or more times into a reactive monomer mixture until the item is covered with a polymer coating having the desired or required thickness. The item or the reactive monomer mixture may or may not be heated during the polymerization process.

4. Continuous Casting: A processing method where one or more reactive streams are used or combined and conveyed between two heated or unheated parallel moving plates or sheets. The two parallel moving plates are separated by a gasket, spacer, or seal, which is sandwiched between them, to form a compartment or cell to contain the reactive monomer mixture during the molding process. The thickness of the gasket, spacer, or seal is used to establish the thickness of the molded polymer part.

5. Embedding: A processing method where one or more reactive streams are used or combined and conveyed into a mold where an item or article has been placed, fixed, mounted or positioned in the mold so that the item is completely submerged or encased in the reactive monomer mixture. The embedding process differs from the encapsulation process in that the shape of the encased item or article does not define the shape of the final polymer part.

6. Potting: A processing method where one or more reactive streams are used or combined and conveyed into a mold where and item or article has been placed, fixed, mounted or positioned in the mold so that the item is completely submerged or encased in the reactive monomer mixture. The shape of the final polymer part is defined by the shape of the mold and not by the shape of the encased item or article.

7. Encapsulation: A processing method where one or more reactive steams are used or combined and conveyed into a mold where and item or article has been placed, fixed mounted or positioned in the mold so that the item is completely submerged or encased in the reactive monomer mixture. The encapsulation process differs from the embedding process in that the shape of the encased item or article defines the shape of the final polymer part.

8. Film Casting or Solvent Casting: A processing method where one or more reactive streams are used or combined and conveyed onto a moving belt, which is coated with a layer of the reactive monomer mixture to yield a polymer film. The moving belt may be heated or unheated.

9. Gated Casting: A processing method where one or more reactive streams are used or combined and conveyed into a gate that directs the reactive monomer mixture into a mold that may be open or closed. The mold may be heated or unheated.

10. Mold Casting: A processing method where one or more reactive streams are used or combined and conveyed into a mold that is open or closed. The mold may be heated or unheated.

11. Multiple Pour Method: A processing method where one or more reactive streams are used or combined and conveyed into a mold. At some point a second reactive monomer mixture is conveyed into the same mold. The reactive stream or streams constituting the second reactive mixture may have the same composition as the initial reactive stream or streams or they may have a different composition. This process of adding reactive monomer mixtures to a mold that have the same composition or many different compositions may be repeated as many times as deemed necessary in order to yield the desired polymer item, part, or article.

12. Mechanical Foaming: A processing method where one or more reactive streams are used or combined and conveyed into a mold or container, to form a reactive monomer mixture, which is mechanically agitated in order to disperse air or other gases throughout the reactive monomer mixture, which can then be shaped or molded. The final foamed polymer part processed using this method is characterized by the formation of small bubbles or pockets throughout the molded part so that either the bubbles or the holes created by the bubbles are present in the final polymer part. There are typically two types of holes or cells that occur in parts made by this process. One type of hole or cell architecture is characterized by a structure in which each of the holes or cells throughout the molded polymer part are separated from one another by the bulk polymer matrix. Another type of hole or cell architecture is characterized by a structure in which some or all of the individual holes are interconnected throughout the final polymer part. If the final foamed polymer is stiff when subjected to external pressure it is typically characterized as rigid foam. If the final foamed polymer is soft or pliable when subjected to external pressure it is typically characterized as flexible foam. Foams made using this process may or may not also possess an integral skin, which is a nonfoamed polymer layer on the outside surface of the foamed polymer part that is caused by the collapse of some of the holes or cells.

13. Chemical Foaming: A processing method where one or more reactive streams are used or combined and mixed with a foaming agent or blowing agent and conveyed into a mold or container to create a foamed polymer part. The actual hole or cell structure of the foamed polymer is formed during the chemical breakdown or degradation of the foaming or blowing agent. The final foamed polymer part processed using this method is characterized by the formation of small bubbles or pockets throughout the molded part so that either the bubbles or the holes created by the bubbles are present in the final polymer part. There are typically two types of holes or cells that occur in parts made by this process. One type of hole or cell architecture is characterized by a structure in which each of the holes or cells throughout the molded polymer part are separated from one another by the bulk polymer matrix. Another type of hole or cell architecture is characterized by a structure in which some or all of the individual holes are interconnected throughout the final polymer part. If the final foamed polymer is stiff when subjected to external pressure it is typically characterized as rigid foam. If the final foamed polymer is soft or pliable when subjected to external pressure it is typically characterized as flexible foam. Foams made using this process may or may not also possess an integral skin, which is a nonfoamed polymer layer on the outside surface of the foamed polymer part that is caused by the collapse of some of the holes or cells.

14. Physical Foaming: A processing method where one or more reactive streams are used or combined and conveyed into a mold or container, to form a reactive monomer mixture, where air or other gases are forced into the reactive monomer mixture, which can then be shaped or molded. The final foamed polymer part processed using this method is characterized by the formation of small bubbles or pockets throughout the molded part so that either the bubbles or the holes created by the bubbles are present in the final polymer part. There are typically two types of holes or cells that occur in parts made by this process. One type of hole or cell architecture is characterized by a structure in which each of the holes or cells throughout the molded polymer part are separated from one another by the bulk polymer matrix. Another type of hole or cell architecture is characterized by a structure in which some or all of the individual holes are interconnected throughout the final polymer part. If the final foamed polymer is stiff when subjected to external pressure it is typically characterized as rigid foam. If the final foamed polymer is soft or pliable when subjected to external pressure it is typically characterized as flexible foam. Foams made using this process may or may not also possess an integral skin, which is a nonfoamed polymer layer on the outside surface of the foamed polymer part that is caused by the collapse of some of the holes or cells.

15. Syntactic Foams: A processing method where one or more reactive streams are used or combined and mixed with hollow glass spheres of various or uniform sizes and various or uniform densities, and conveyed into a mold or container to create a foamed polymer part. If the spheres have a density that is less than that of the reactive monomer mixture then the final polymer part will have physical properties and characteristics of a foamed polymer part. Polymers processed using this method are referred to as syntactic foams. Foams made using this process may or may not also possess an integral skin, which is a nonfoamed polymer layer on the outside surface of the foamed polymer part that is caused by the collapse of some of the holes or cells.

16. Compression Molding or Matched Die Molding: A processing method where one or more reactive streams are used or combined and conveyed into the “female” or cavity section of a matched or mated mold while the mold is in the open position. The mold is then closed so that the “female” or cavity section is match or brought together with the corresponding “male” or core section of the mold. During this process of closing the mold or matching the two mold halves pressure is exerted on the reactive monomer mixture forcing it to simultaneously and uniformly fill the mold cavity forming the final polymer part. The mold may or may not be heated during this process. Once the reactive monomer mixture has polymerized and a certain degree of cure or crosslinking has been achieved the mold is opened or the two mold halves are separated and the molded part is removed from the mold.

17. Transfer Molding: A processing method where one or more reactive streams are used or combined and conveyed into a transfer chamber or container. The transfer chamber or container may or may not be heated. The transfer chamber may be open or closed. The reactive monomer mixture is then conveyed from the transfer chamber or container into a mold. The mold may be open or closed during the molding process. The mold may or may not be heated.

18. Resin Transfer Molding: A processing method where one or more reactive streams are used or combined and conveyed into a mold in which one or more types of reinforcing materials may have been placed and positioned in the mold prior to closing the mold. Once the mold is closed the reactive monomer mixture is conveyed into the mold and the reinforcing material, if utilized, is incorporated into the final polymer part.

20. Vacuum Assisted Resin Transfer Molding: A processing method in which one or more types of reinforcing materials may be placed and arranged in the cavity section of a mold, in which the core section of the mold is covered with a separate set of reinforcing material or materials. The mold is then encapsulated in a bag and one or more reactive streams are used or combined and conveyed into the heated or unheated mold and the reinforcing materials are impregnated with the reactive monomer mixture under a vacuum to form the final polymer part. The reinforcing materials if used in the cavity and core sections of the mold may be composed of the same type of material or they may be composed of two or more different types of materials.

21. Spray-up: A processing method in which one or more reactive streams are used or combined in a spray gun, which may be attached to fiber chopping apparatus. As the reactive monomer mixture is sprayed from the spray gun the monomer mixture picks up and coats or wets the chopped fibers. These chopped fibers if utilized are then directed onto a mold surface or into a mold cavity to form the final reinforced polymer part.

22. Filament Winding: A processing method where fibers or strands of fibrous material may be attached to a mandrel whereby the mandrel is turned to draw the fibers off of a spool or some other type of dispensing unit. The fibers are gathered together into a guide, which may be mounted on a carriage or some other type of transport system, which moves laterally along the length or long axis of the mandrel as the fibers are being drawn off a spool or some other type of dispensing unit and are being wrapped around or wound around the mandrel. The motion of the guide is synchronized with the turning or rotation of the mandrel such that a pattern of fibers is produced on the mandrel. The overall fiber pattern and the angles of the fiber pattern are determined by the relative motion and speed of the mandrel and the guide. The fibers or strands of fibrous material may be coated with a reactive monomer mixture or composition at some point before or after they are wrapped around or wound around the mandrel. The mandrel may or may not be heated during the filament winding process. The geometric shape of the mandrel may or may not determine the geometric shape of the final polymer part. The reactive monomer mixture may or may not be heated during the filament winding process.

23. Fiber Placement: A processing method where fibrous material is pressed against a mandrel by some method such that the surface or a portion of the surface of the mandrel is covered with one or more layers of fibrous material. The fibrous material may be coated with a reactive monomer mixture at some point before or after they are placed or positioned on the mandrel. The mandrel may or may not be heated during the fiber placement process. The geometric shape of the mandrel may or may not determine the geometric shape of the final polymer part.

24. Pultrusion: A processing method where a reinforcing agent or material is pulled through and coated or wetted with a reactive monomer mixture. The coated or wetted reinforcing agent or material is then pulled through a tool that makes a continuous reinforced or composite part that has the same cross section and geometric shape as the tool. The reactive monomer mixture may or may not be heated during the pultrusion process. The tool may or may not be heated during the pultrusion process.

25. Extrusion: A processing method where one or more reactive streams are used or combined and conveyed into a shaping tool. The reactive monomer mixture is then forced through or pushed through the tool that makes a continuous polymer part that has the same cross section and geometric shape as the tool. The reactive monomer mixture may or may not be heated during the extrusion process. The shaping tool may or may not be heated during the extrusion process. The extrusion method may also be used with a thermoplastic or elastomeric norbornene-type polymer where the thermoplastic or elastomeric polymer is conveyed into a hopper attached to a traditional extrusion machine. In this type of extrusion process, material from the hopper passes through a opening in the top of the extruder onto the extrusion screw. This screw, which rotates or turns inside the extruder barrel, pushes or conveys the polymer into a heated region of the extruder barrel. The external heating and heating from internal friction causes the polymer to melt. The extrusion screw conveys the molten polymer forward through an opening in the end of the extruder barrel and into a shaping tool. The molten polymer is then cooled to form a solid polymer part that has the same cross section and geometric shape as the shaping tool.

26. Slush Casting: A processing method where one or more reactive streams are used or combined and conveyed into a heated or unheated mold that can be rotated about one or more axes or that can be rocked back and forth. The rotation and/or rocking motion of the mold distributes the reactive mixture inside the mold causing it to stick to or coat the walls of the mold. Once the walls of the mold have been coated with a layer of the reactive monomer mixture the excess reactive mixture may be removed from the mold allowing for the formation of a hollow polymer part.

27. Centrifugal Casting: A processing method where one or more reactant streams are used or combined and conveyed into a heated or unheated cylindrical mold that is rotated about an axis at high speeds as the reactive monomer mixture is conveyed into the mold. The reactive monomer mixture is centrifugally thrown or dispersed towards the inside walls of the mold allowing for the formation of a cylindrical polymer part.

28. Hand Lay-up: A processing method where one or more reactive streams are used or combined and conveyed into a mold where one or more types of reinforcing and/or filler materials have been placed and positioned in the mold by hand. The reinforcing and/or materials may be placed in the mold prior to adding the reactive monomer mixture to the mold. The reinforcing and/or filling materials may be placed in the mold after the reactive monomer mixture is added to the mold. The reinforcing and/or filling materials may be placed in the mold simultaneously as the reactive monomer mixture is added to the mold.

29. Reaction Injection Molding: A processing method where one or more reactive streams are used or combined and/or mixed at a given ratio, temperature, and pressure and conveyed into a mold. If more than one reactive stream is used the reactive streams may be combined and/or mixed in a special mixing head and then conveyed into a mold. The mold may or may not be heated during the molding process. The mold may be open or closed during the molding process.

30. Seeman's Composite Resin Infusion Molding Process (SCRIMP): An advanced form of vacuum assisted resin transfer molding.

31. Coating or Painting: A processing method where one or more reactive streams are used or combined to form a reactive monomer mixture, which may be sprayed, brushed, poured, spread, coated, wiped, smeared or applied onto a surface, item, part, material, or article.

33. Blow Molding: A processing method where a preform polymer item, part, or article is heated and inflated with air or another gas or a mixture of gases such that pressure is exerted outward against the cavity walls of the preform polymer item, part, or article allowing for the formation of a hollow polymer part. A heated or unheated mold may or may not be used in this process to shape the final polymer part. The preform polymer item, part, or article may be prepared by using any of the processing methods listed in this document.

34. In-Mold Coating: A processing method where one or more reactive streams are used or combined and conveyed into a heated or unheated mold, where the surface or surfaces of the mold have been coated or painted with a material prior to the introduction of the reactive monomer mixture. This processing method allows for the formation of molded polymer parts where the surface or surfaces of the final polymer part possess a coated or paint-like finish before being removed from the mold. The mold may be open or closed during the molding process.

35. In-Mold Painting or Injection In-Mold Coating: A processing method where one or more reactive streams are used or combined and conveyed into a heated or unheated closed mold to create a polymer part, article, or item. Once the polymer part has cured or crosslinked entirely or to some degree the mold is opened and paint or paint-like material is injected into the mold where it coats one or more surfaces of the molded polymer part. In another version of this processing method, paint or paint-like material may be injected into one or more sections of the mold where the molded polymer part has pulled or shrunk away from the mold surface or surfaces creating a void, series of voids, or a uniform void between the molded polymer part and the mold surface or surfaces. If the shrinkage of the molded polymer part is uniform throughout the polymer part a paint or paint-like material may be applied to one or more of the polymer surfaces before the part is removed from the mold. This processing method, in some variation, allows for the formation of molded polymer parts where the surface or surfaces of the final polymer part possess a coated or paint-like finish before being removed from the mold.

36. Vacuum Forming: A processing method in which a preform or thermoplastic polymer item, part, or article is placed in a mold or wrapped around or placed on the surface or around the body of a mandrel where the surface of the mold or mandrel possess numerous pores or holes, which may or may not extend throughout the body of the mold or mandrel. Once the preform or thermoplastic polymer part is placed on the mold or mandrel a vacuum is applied to the mold or mandrel forcing the preform or thermoplastic polymer part to conform to the geometric shape of the mold or mandrel.

40. Container Mixing: A processing method where one or more reactive streams are used or combined and conveyed into a container, whereby the reactive monomer mixture that is formed can be used separately or in combination with one or more processing methods.

41. Infusion or Resin Infusion: A processing method where one or more reactive streams are used or combined to form a reactive monomer mixture, which is forced or pushed into a porous part, item, or article. The reactive monomer mixture may or may not be heated. The porous part, item, or article may or may not be heated.

42. Laminate: A processing method where one or more reactive streams are used or combined to form a reactive monomer mixture containing one or more fillers and/or reinforcing materials to form a multilayered composite or nanocomposite polymer part, item, or article.

43. Nanocomposites: A processing method where one or more reactive streams are used or combined to form a polymer part, item, or article containing one or more fillers and/or reinforcing materials where the size, length, or diameter of the filler and/or reinforcing material is measured on a nanometer scale. The length or diameter of the fillers and/or reinforcing materials used in these types of composite polymer materials is typically 500 nm or less.

### Ruthenium or Osmium Metathesis Catalysts

The terms “catalyst” and “initiator” are used interchangeably in this document.

### 1. Pentacoordinated Ruthenium or Osmium Metathesis Catalysts:

The pentacoordinated ruthenium or osmium metathesis catalysts for use with or in this invention have been described in, for example, U.S. Pat. Nos. 5,312,940, 5,342,909, 5,728,917, 5,750,815, 5,710,298 and 5,831,108, 5,922,863 and PCT Publications WO 97/20865 and WO 97/29135 the contents of each of which are included herein by reference in their entirety including the contents of all cited references, including without limitation U.S. Patent Documents, Foreign Patent Documents, and other publications. These patents and publications describe well-defined single component ruthenium or osmium catalysts that possess several advantageous properties. For example, these catalysts are tolerant to a variety of functional groups and generally are more active than previously known metathesis catalysts. The ruthenium and osmium complexes disclosed in these patents all possess metal centers that are formally in the +2 oxidation state, have an electron count of 16, and are pentacoordinated. These complexes possess the following general structure,

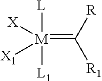

and are useful as initiators in the ring-opening metathesis polymerization (ROMP) of strained cycloolefins, such as norbornene, dicyclopentadiene, tricyclopentadiene, and functionalized norbornenes
wherein:
   M is ruthenium or osmium;
   X and X₁ are the same or different and are each independently an anionic ligand;
   L, and L₁ are the same or different and are each independently a neutral electron donor ligand, wherein at least one L, and L₁ may be an N-heterocyclic carbene ligand; and,
   R and R₁ are each independently hydrogen or a substituent selected from the group consisting of C₁-C₂₀ alkyl, C₂-C₂₀ alkenyl, C₂-C₂₀ alkynyl, aryl, C₁-C₂₀ carboxylate, C₁-C₂₀ alkoxy, C₂-C₂₀ alkenyloxy, C₂-C₂₀ alkynyloxy, aryloxy, C₂-C₂₀ alkoxycarbonyl, C₁-C₂₀ alkylthio, C₁-C₂₀ alkylsulfonyl and C₁-C₂₀ alkylsulfinyl. Optionally, each of the R or R₁ substituent group may be substituted with one or more moieties selected from the group consisting of C₁-C₁₀ alkyl, C₁-C₁₀ alkoxy, and aryl, which in turn may each be further substituted with one or more groups selected from a halogen, a C₁-C₅ alkyl, C₁-C₅ alkoxy, and phenyl. Moreover, any of the catalyst ligands may further include one or more functional groups. Examples of suitable functional groups include but are not limited to: hydroxyl, thiol, thioether, ketone, aldehyde, ester, ether, amine, imine, amide, nitro, carboxylic acid, disulfide, carbonate, isocyanate, carbodiimide, carboalkoxy, carbamate, and halogen.

In embodiments, (i) L and L₁ are both phosphines; or (ii) L is a phosphine and L₁ is an N-heterocyclic carbene ligand.

Other general structures of pentacoordinated ruthenium or osmium catalyst for use in this invention include:

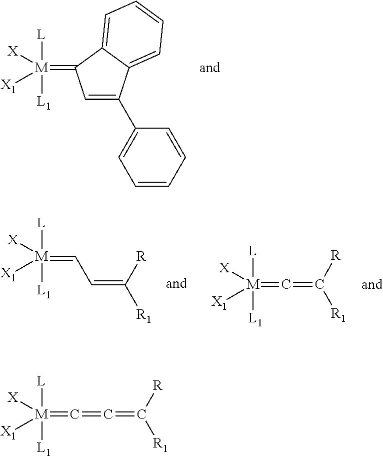

wherein:
   M is ruthenium or osmium;
   X and X₁ are the same or different and are each independently an anionic ligand;
   L, and L₁ are the same or different and are each independently a neutral electron donor ligand, wherein at least one L, and L₁ may be an N-heterocyclic carbene ligand; and,
   R and R₁ are each independently hydrogen or a substituent selected from the group consisting of C₁-C₂₀ alkyl, C₂-C₂₀ alkenyl, C₂-C₂₀ alkynyl, aryl, C₁-C₂₀ carboxylate, C₁-C₂₀ alkoxy, C₂-C₂₀ alkenyloxy, C₂-C₂₀ alkynyloxy, aryloxy, C₂-C₂₀ alkoxycarbonyl, C₁-C₂₀ alkylthio, C₁-C₂₀ alkylsulfonyl and C₁-C₂₀ alkylsulfinyl. Optionally, each of the R or R₁ substituent group may be substituted with one or more moieties selected from the group consisting of C₁-C₁₀ alkyl, C₁-C₁₀ alkoxy, and aryl, which in turn may each be further substituted with one or more groups selected from a halogen, a C₁-C₅ alkyl, C₁-C₅ alkoxy, and phenyl. Moreover, any of the catalyst ligands may further include one or more functional groups. Examples of suitable functional groups include but are not limited to: hydroxyl, thiol, thioether, ketone, aldehyde, ester, ether, amine, imine, amide, nitro, carboxylic acid, disulfide, carbonate, isocyanate, carbodiimide, carboalkoxy, carbamate, and halogen.

In embodiments, (i) L and L₁ are both phosphines; or (ii) L is a phosphine and L₁ is an N-heterocyclic carbene ligand.

The ring-opening metathesis polymerization (ROMP) of and addition polymerization of polycyclic olefins is depicted generally in the following reaction schemes:

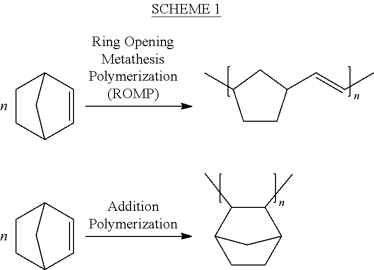

These compounds are also useful entry complexes for the following metathesis processes including, without limitation: addition polymerization metathesis, ring opening metathesis polymerization (ROMP), ring-closing metathesis (RCM), asymmetric olefin metathesis, acyclic diene metathesis (ADMET), and cross metathesis (CM), ring expansion metathesis polymerization (REMP), and degenerative olefin metathesis (DOM).

It is now well recognized that one of the more active ruthenium initiator species for olefin metathesis contains a saturated or an unsaturated N-heterocyclic carbene (NHC) moiety. The increased activity of this moiety is reported in, for example, PCT Publications WO 99/51344, WO 00/15339, WO 00/15339, and WO 00/58322, the contents of each of which are included herein by reference in their entirety including the contents of all cited references, including without limitation U.S. Patent Documents, Foreign Patent Documents, and other publications.

### 2. Hexacoordinated Ruthenium or Osmium Metathesis Catalysts:

The hexacoordinated ruthenium or osmium catalysts for use with or in this invention have been described in U.S. Pat. Nos. 6,818,586 and 6,759,537 the contents of each of which are included herein by reference in their entirety including the contents of all cited references, including without limitation U.S. Patent Documents, Foreign Patent Documents, and other publications.

The present invention relates to novel hexacoordinated metathesis catalysts and to methods for making and using the same. The inventive catalysts are of the formula

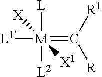

wherein:
   M is ruthenium or osmium;
   X and X¹ are the same or different and are each independently an anionic ligand;
   L, L^{1′} and L² are the same or different and are each independently a neutral electron donor ligand, wherein at least one L, L^{1′} and L² is an N-heterocyclic carbene ligand; and,

R and R¹ are each independently hydrogen or a substituent selected from the group consisting of C₁-C₂₀ alkyl, C₂-C₂₀ alkenyl, C₂-C₂₀ alkynyl, aryl, C₁-C₂₀ carboxylate, C₁-C₂₀ alkoxy, C₂-C₂₀ alkenyloxy, C₂-C₂₀ alkynyloxy, aryloxy, C₂-C₂₀ alkoxycarbonyl, C₁-C₂₀ alkylthio, C₁-C₂₀ alkylsulfonyl and C₁-C₂₀ alkylsulfinyl. Optionally, each of the R or R¹ or R′ or R″ substituent group may be substituted with one or more moieties selected from the group consisting of C₁-C₁₀ alkyl, C₁-C₁₀ alkoxy, and aryl, which in turn may each be further substituted with one or more groups selected from a halogen, a C₁-C₅ alkyl, C₁-C₅ alkoxy, and phenyl. Moreover, any of the catalyst ligands may further include one or more functional groups. Examples of suitable functional groups include but are not limited to: hydroxyl, thiol, thioether, ketone, aldehyde, ester, ether, amine, imine, amide, nitro, carboxylic acid, disulfide, carbonate, isocyanate, carbodiimide, carboalkoxy, carbamate, and halogen.

In embodiments, L² and L^{1′} are pyridine and L is a phosphine or an N-heterocyclic carbene ligand. Examples of N-heterocyclic carbene ligands include:

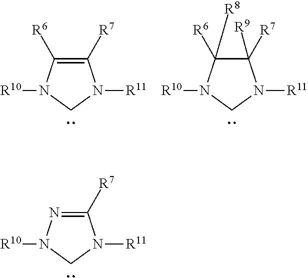

wherein R, R¹, R⁶, R⁷, R⁸, R⁹, R¹⁰ and R¹¹ are each independently hydrogen or a substituent selected from the group consisting of C₁-C₂₀ alkyl, C₂-C₂₀ alkenyl, C₂-C₂₀ alkynyl, aryl, C₁-C₂₀ carboxylate, C₁-C₂₀ alkoxy, C₂-C₂₀ alkenyloxy, C₂-C₂₀ alkynyloxy, aryloxy, C₂-C₂₀ alkoxycarbonyl, C₁-C₂₀ alkylthio, C₁-C₂₀ alkylsulfonyl and C₁-C₂₀ alkylsulfinyl. Optionally, each of the R, R¹, R⁶, R⁷, R⁸, R⁹, R¹⁰ and R¹¹ substituent group may be substituted with one or more moieties selected from the group consisting of C₁-C₁₀ alkyl, C₁-C₁₀ alkoxy, and aryl, which in turn may each be further, substituted with one or more groups selected from a halogen, a C₁-C₅ alkyl, C₁-C₅ alkoxy, and phenyl. Moreover, any of the catalyst ligands may further include one or more functional groups. Examples of suitable functional groups include but are not limited to: hydroxyl, thiol, thioether, ketone, aldehyde, ester, ether, amine, imine, amide, nitro, carboxylic acid, disulfide, carbonate, isocyanate, carbodiimide, carboalkoxy, carbamate, and halogen. The inclusion of an NHC ligand to the hexacoordinated ruthenium or osmium catalysts has been found to dramatically improve the properties of these complexes. Because the NHC-based hexacoordinated complexes are extremely active, the amount of catalysts that is required is significantly reduced.

Other general structures of hexacoordinated ruthenium or osmium catalyst for use in this invention include:

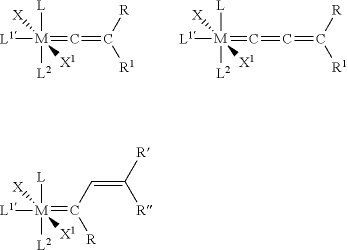

### System Components

1. Solvents:

Solvents that may be used as a system component in one or more of the reactant streams include but are not limited to alkane and cycloalkane solvents such as mineral oil, pentane, hexane, heptane, and cyclohexane; halogenated alkane solvents such as dichloromethane, chloroform, carbon tetrachloride, ethylchloride, 1,1-dichloroethane, 1,2-dichloroethane, 1-chloropropane, 2-chloropropane, 1-chlorobutane, 2-chlorobutane, 1-chloro-2-methylpropane, and 1-chloropentane; ethers such as THF and diethylether; aromatic solvents such as benzene, xylene, toluene, mesitylene, chlorobenzene, and o-dichlorobenzene; and halocarbon solvents such as Freon® 112; and mixtures thereof. Solvents include benzene, fluorobenzene, o-difluorobenzene, p-difluorobenzene, pentafluorobenzene, hexafluorobenzene, o-dichlorobenzene, chlorobenzene, toluene, o-, m-, and p-xylenes, mesitylene, cyclohexane, THF, dichloromethane, liquid rubbers, and liquid antioxidants.

2. NHC—X—Y Species

The types of, application of, and preparation of thermally activated N-Heterocyclic Carbene precursors for use with or in this invention have been described in U.S. Pat. No. 6,838,489 the contents of which are included herein by reference in its entirety including the contents of all cited references, including without limitation U.S. Patent Documents, Foreign Patent Documents, and other publications.

The following structure NHC—X—Y indicates generically the protected form of a N-Heterocyclic Carbene (NHC).

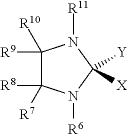

It is also envisioned that the protected NHC—X—Y may be of an unsaturated variety, such as

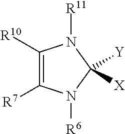

wherein R⁶, R⁷, R⁸, R⁹, R¹⁰ and R¹¹ are as previously defined.

As shown in Schemes 5a and 5b, the approach taken in this invention relates to the thermal generation of a NHC from a stable (protected) NHC derivative with release of a quantity of X—Y.

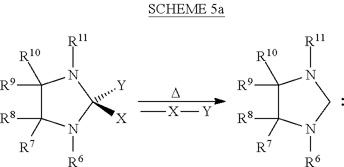

and

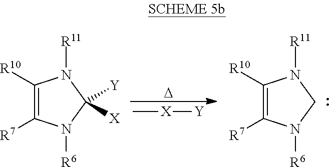

One of the methods to generate a reactive NHC is to employ a stable carbene precursor where the X—Y compound is also a reactive NHC, as shown in Schemes 6a and 6b:

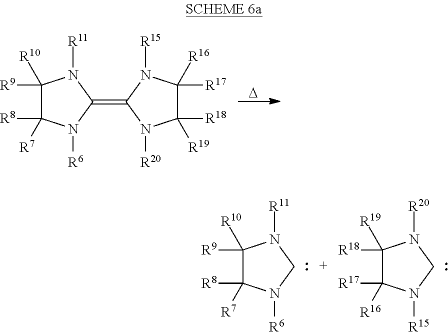

and

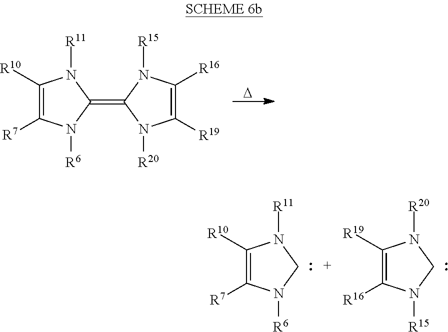

wherein R⁶, R⁷, R⁸, R⁹, R¹⁰ and R¹¹ are as previously defined and wherein R¹⁵, R¹⁶, R¹⁷, R¹⁸, R¹⁹ and R²⁰ is independently selected from the group consisting of the moieties in which R⁶, R⁷, R⁸, R⁹, R¹⁰ and R¹¹ are selected from.

The first derivative investigated was 1,3-dimesityltrichloromethylimidazoline (s-ImesCHCl₃) (I), i.e.,

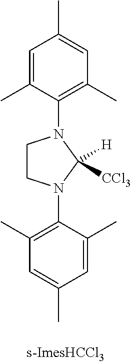

where R¹ and R⁶, =2,4,6-trimethylphenyl and R¹, R², R³, and R⁴=H and X=H and Y=CCl₃. The carbene generated from (I) exists solely as a monomeric species and has no tendency to dimerize under normal conditions. The monomeric nature of the carbene makes it suitable for in-situ generation and reaction with a transition metal containing species.

As described in Arduengo et. al., Helvetica Chimica Acta, 82, (1999), the contents of which are incorporated herein by reference, the 1,3-dimesityltrichloromethylimidazoline starting material can be synthesized by generating the 1,3-dimesityldihydroimidazoline by deprotonation using bases, i.e., potassium hydride (KH), lithium diisopropylamide (LiN(CHMe₂)₂ or LDA), potassium bis(trimethylsilyl)amide (KN(SiMe₃)₂), sodium methoxide (NaOMe), and potassium tert-butoxide (KOBu^{t}), and reacting the NHC formed with chloroform in hexane at room temperature. Alternatively and as disclosed in U.S. Pat. No. 4,161,528, the contents of which are included herein by reference in its entirety including the contents of all cited references, including without limitation U.S. Patent Documents, Foreign Patent Documents, and other publications, compound I may be generated from the appropriate aniline, dibromoethane, and chloral. Alternatively, the reaction of the ether s-IMes(H)(OCMe₃), formed by the action of KOCMe₃ on the imidazolium chloride salt (S-ImesHCl), with excess chloroform (CHCl₃) in refluxing mixture of chloroform and hexane leads to generation of 1,3-dimesityltrichloromethylimidazoline.

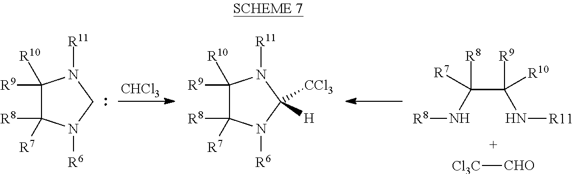

Likewise, the dimethylamine protected forms of imidazolines can be generated from the reaction of equimolar portions of the appropriate diamine and tris(dimethylamino)methane (CH(NMe₂)₃) or tert-butoxy(bisdimethylamino)methane (CH(NMe₂)₂OBu^{t}), as described in, for example, Lappert et al. J. Chem. Soc., Perkin Trans. 1 (1998), (13), 2047-2054, the contents of which are incorporated herein by reference:

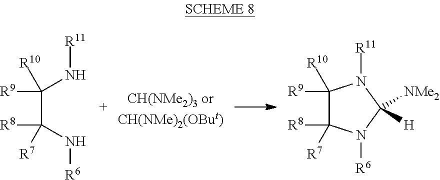

The family of compounds for use in the invention are of the general formula, NHC—X—Y, that when heated to the appropriate temperature or provided with enough energy generate the free N-heterocyclic carbene and release the X—Y moiety.

In the above structures, X is H and Y may be selected from the group consisting of CCl₃; CH₂SO₂Ph; C₆F₅; OR²¹; and N(R²²)(R²³), wherein R²¹ is selected from the group consisting of Me, C₂H₅, i-C₃H₇, CH₂CMe₃, CMe₃, C₆H₁₁ (cyclohexyl), CH₂Ph, CH₂norbornyl, CH₂norbornenyl, C₆H₅, 2,4,6-(CH₃)₃C₆H₂ (mesityl), 2,6-i-Pr₂C₆H₂, 4-Me-C₆H₄ (tolyl), 4-Cl—C₆H₄; and wherein R²² and R²³ are independently selected from the group consisting of Me, C₂H₅, i-C₃H₇, CH₂CMe₃, CMe₃, C₆H₁₁ (cyclohexyl), CH₂Ph, CH₂norbornyl, CH₂norbornenyl, C₆H₅, 2,4,6-(CH₃)₃C₆H₂ (mesityl), 2,6-i-Pr₂C₆H₂, 4-Me-C₆H₄ (tolyl), 4-Cl—C₆H₄).

In embodiments of the NHC—X—Y, R⁷, R⁸, R⁹ and R¹⁰ are each independently selected from the group consisting of hydrogen, methyl, aralkyl, and aryl and R⁶ and R¹¹ are each independently selected from the group consisting of substituted or unsubstituted C₁-C₁₀ alkyl, C₁-C₁₀ cycloalkyl, C₂-C₁₀ alkenyl, aralkyl, and aryl. In embodiments, the R⁷, R⁸, R⁹ and R¹⁰ are each hydrogen and R⁶ and R¹¹ substituents are selected from the group consisting of phenyl, methyl, isopropyl, tert-butyl, neopentyl, or benzyl, each optionally substituted with one or more moieties selected from the group consisting of C₁-C₅ alkyl, C₁-C₅ alkoxy, phenyl, and a functional group. In embodiments, R⁶ and R¹¹ are phenyl optionally substituted with one or more moieties independently selected from the group consisting of chloride, bromide, iodide, fluoride, —NO₂, —NMe₂, methyl, methoxy, and phenyl.

In the embodiments, R⁶ and R¹¹ are either substituted or unsubstituted aryl. Without being bound by theory, it is believed that the bulkier R⁶ and R¹¹ groups result in initiators with improved characteristics such as thermal and oxidative stability. In the embodiments, R⁶ and R¹¹ are the same and each is independently of the formula:

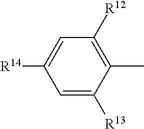

wherein R¹², R¹³, and R¹⁴ are independently hydrogen, C₁-C₁₀ alkyl, C₁-C₁₀ alkoxy, aryl, or a functional group selected from the group consisting of hydroxyl, thiol, thioether, ketone, aldehyde, ester, ether, amine, imine, amide, nitro, carboxylic acid, disulfide, carbonate, isocyanate, carbodiimide, carboalkoxy, carbamate, and halogen. In embodiments, R¹², R¹³, and R¹⁴ may each independently selected from the group consisting of hydrogen, methyl, ethyl, propyl, isopropyl, hydroxyl, and halogen. In the embodiments, R¹², R¹³, and R¹⁴ may the same and are each methyl.

In another embodiment, any or all of the groups, R⁷, R⁸, R⁹ and R¹⁰, if present, may be linked to form an substituted or unsubstituted, saturated or unsaturated ring structure. In addition, R⁶ and R¹¹ may be linked. The unsaturated ring structure can be aromatic or formed of discrete carbon-carbon single and double bonds. Examples of such ringed species include:

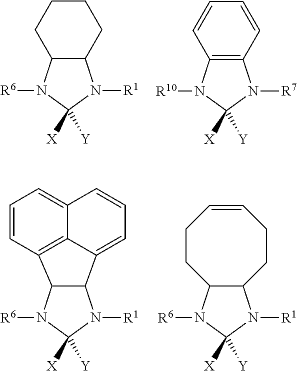

Examples of the embodiments for use in the invention include:

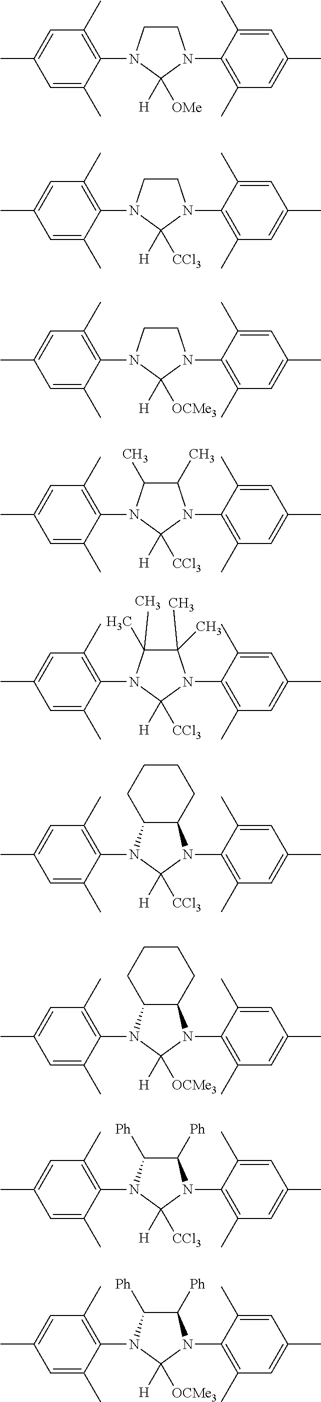

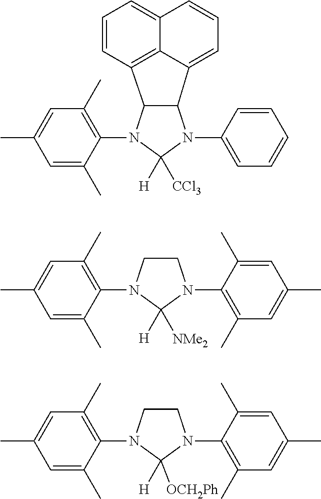

Examples of such di-carbene species, where X—Y is an NHC, are

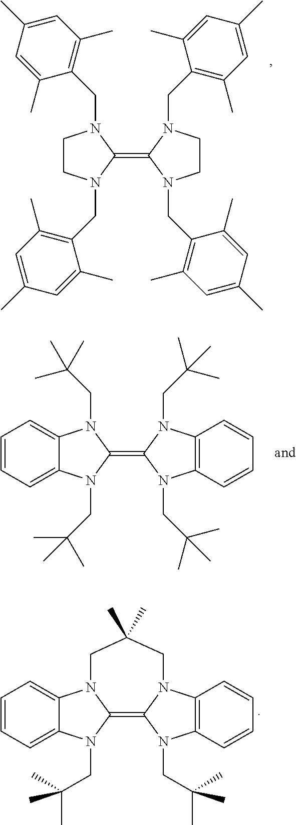

In the case of the tetraminoethylene compounds, those skilled in the art should be able to determine some idea as to the strength of the carbon-carbon double bond (or carbene stability versus dimerization), which is needed in order to gauge its usefulness as a NHC source.

Specific examples of the NHC—X—Y species are 1,3-dimesityl-2-methoxy-imidazolidine, 1,3-dimesityl-2-ethoxy-imidazolidine, 1,3-dimesityl-2-tert-butoxy-imidazolidine, 1,3-dimesityl-2-benzyloxy-imidazolidine, 1,3-diphenyl-2-(trichloromethyl)imidazolidine, 1,3-bis(3-chlorophenyl)-2-(trichloromethyl)imidazolidine, 1,3-bis(4-methylphenyl)-2-(trichloromethyl)imidazolidine, 1,3-bis(4-fluorophenyl)-2-(trichloromethyl)imidazolidine, 1,3-bis(3-methylphenyl)-2-(trichloromethyl)imidazolidine, 1,3-bis(4-chlorophenyl)-2-(trichloromethyl)imidazolidine, 1,3-bis(4-bromophenyl)-2-(trichloromethyl)imidazolidine, 1,3-bis(4-iodophenyl)-2-(trichloromethyl)imidazolidine, 1,3-bis(4-methoxyphenyl)-2-(trichloromethyl)imidazolidine, 1,3-bis(4-ethoxyphenyl)-2-(trichloromethyl)imidazolidine, 1,3-bis(4-ethylphenyl)-2-(trichloromethyl)imidazolidine, 1,3-bis(4-nitrophenyl)-2-(trichloromethyl)imidazolidine, 1,3-bis(3,4-dimethylphenyl)-2-(trichloromethyl)imidazolidine, 1,3-bis(3,5-dichlorophenyl)-2-(trichloromethyl)imidazolidine, 1,3-bis(3,5-dimethylphenyl)-2-(trichloromethyl imidazolidine, 1-(4-chlorophenyl)-3-phenyl-2-(trichloromethyl)imidazolidine, 1,3-bis(4-fluorophenyl)-2-(trichloromethyl)imidazolidine, 1-(4-methoxyphenyl)-3-phenyl-2-(trichloromethyl imidazolidine, 2-(trichloromethyl)-1,3-bis(2,6-dimethyl-4-tert-butylphenyl)imidazolidine, 2-(trichloromethyl)-1,3-bis(2,6-diisopropylphenyl)imidazolidine, 1,3-dimesityl-2-dimethylamino-imidazolidine, 1-(1,3-dimesityl-2-imidazolidinyl)-piperidine, and, 4-(1,3-dimesityl-2-imidazolidinyl)-morpholine.

### 3. Modifying Rate of Catalyst Generation, Controlling Catalyst Reactivity, and Polymerization Activity

The present invention may be practiced under a relatively wide variety of conditions of reaction time, temperature, pressure, reactant phase, and mixing. Selection of conditions is a function of the reactivity of the feed monomer(s), the activity and selectivity of the initiator, rate of deprotection of the NHC—X—Y and the type of polymer desired.

Control over gel and cure time may be important in some of the process methods listed and described in this document. The control of gel and cure in this invention can be derived from a number of sources. “Indigenous” (meaning native or established by the components) or “exogeneous” (meaning external additives or other reactives that can be added to the system).

By far the simplest method of controlling the reactivity of the catalyst system is to regulate the character of the ligands attached to the ruthenium or osmium derivatives. Correct ligand selection is key to the molding with indigenous reactivity control agents. For example, RuCl₂(PPh₃)₂(=CHPh) reacts more slowly than the RuCl₂(PCy₃)₂(=CHPh). The alkylidene substituents may also be changed to control the gel and cure times of the of the generated catalyst system. Likewise, the character of the leaving group (X—Y) of the NHC—X—Y can influence the rate of the reaction, i.e., CHCl₃ eliminates more cleanly from the NHC—X—Y than does HOCMe₃.

Likewise, the desired gel and cure of the system can be achieved by proper selection of a rate moderating ligand (exogeneous reactivity control).

The use of Lewis base rate moderators in this system is optional, i.e., external or “exogeneous” modification, resulting in further gel and cure time control. Suitable exogeneous rate moderators include, for example, water, tetrahydrofuran (THF), 2-methyltetrahydrofuran (2-Me-THF), diethyl ether ((C₂H₅)₂O), methyl-tert-butyl ether (CH₃OC(CH₃)₃), dimethoxyethane (CH₃OCH₂CH₂OCH₃), diglyme (CH₃OCH₂OCH₂OCH₃), trimethylphosphine (PMe₃), triethylphosphine (PEt₃), tributylphosphine (PBu₃), tri(ortho-tolyl)phosphine (P-o-tolyl₃), tri-tert-butylphosphine (P-tert-Bu₃), tricyclopentylphosphine (PCyclopentyl₃), tricyclohexylphosphine (PCy₃), triisopropylphosphine (P-i-Pr₃), trioctylphosphine (POct₃), triphenylphosphine (PPh₃), tri(pentafluorophenyl)phosphine (P(C₆F₅)₃), methyldiphenylphosphine (PMePh₂), dimethylphenylphosphine (PMe₂Ph), trimethylphosphite (P(OMe)₃), triethylphosphite (P(OEt)₃), triisopropylphosphite (P(O-i-Pr)₃), ethyl diphenylphosphinite (P(OEt)Ph₂), tributylphosphite (P(OBu)₃), triphenylphosphite (P(OPh)₃, diethylphenylphosphonite (P(OEt)₂Ph), and tribenzylphosphine (P(CH₂Ph)₃), 2-cyclohexenone, and triphenylphosphine oxide. The exogeneous rate moderators may be triphenylphosphine and triphenylphosphine oxide.

Further, the exogeneous control over reactivity can be achieved by attaching the Lewis base species to a polymerizable monomer. In this way, the moderator can be polymerized into the polymeric structure giving the system important functionality. Examples of suitable functional groups are ethers, trialkoxysilanes, esters, carboxylic acids, and alcohols. Specific examples are triethoxysilylnorbornene, norbornene methanol, and butoxynorbornene.

Further, the exogeneous control over the reactivity, particularly with molybdenum and tungsten based catalysts, can be achieved by adding compounds containing an acetylene moiety including without limitation 4-octyne or phenylacetylene.

The molding of polymerizable monomers can be achieved using a moderator (exogeneous) to initiator (based on Ru or Os) molar ratio from about 100:1 to about 0.01:1, 10:1 to 0.1:1, or from 5:1 to about 0.5:1, or from about 2:1 to about 1:1.

### 4. Antioxidants and Antiozonants

Antioxidants and antiozonants include any antioxidant or antiozonant used in the rubber or plastics industry. An “Index of Commercial Antioxidants and Antiozonants, Fourth Edition” is available from Goodyear Chemicals, The Goodyear Tire and Rubber Company, Akron, Ohio 44316. The antioxidants can be without limitation phenol, phosphorus, sulfur, or amine based compounds. The antioxidants can be used singly, or in combination. The formulation ratio is more than 0.05 part or 0.5 to 100 parts by polymer weight. The antioxidant may be copolymerized with the monomer such as 5-(3,5-di-tert-butyl-4-hydroxybenzyl-2-norbornene, which is a norbornenylphenol based compound (See Japanese Kokai No: 57-83522). Suitable stabilizers may be selected from the following group without limitation: 2,6-di-tert-butyl-4-methylphenol (BHT); styrenated phenol, such as Wingstay S (Goodyear); 2- and 3-tert-butyl-4-methoxyphenol; alkylated hindered phenols, such as Wingstay C (Goodyear); 4-hydroxymethyl-2,6-di-tert-butylphenol; 2,6-di-tert-butyl-4-sec-butylphenol; 2,2′-methylenebis(4-methyl-6-tert-butylphenol); 2,2′-methylenebis(4-ethyl-6-tert-butylphenol); 4,4′-methylenebis(2,6-di-tert-butylphenol); miscellaneous bisphenols, such as Cyanox 53 and Permanax WSO; 2,2′-ethylidenebis(4,6-di-tert-butylphenol); 2,2′-methylenebis(4-methyl-6-(1-methylcyclohexyl)phenol); 4,4′-butylidenebis(6-tert-butyl-3-methylphenol); polybutylated Bisphenol A; 4,4′-thiobis(6-tert-butyl-3-methylphenol); 4,4′-methylenebis(2,6-dimethylphenol); 1,1′-thiobis(2-naphthol); methylene bridged polyaklylphenol, such as Ethyl antioxidant 738; 2,2′-thiobis(4-methyl-6-tert-butylphenol); 2,2′-isobutylidenebis(4,6-dimethylphenol); 2,2′-methylenebis(4-methyl-6-cyclohexylphenol); butylated reaction product of p-cresol and dicyclopentadiene, such as Wingstay L; tetrakis(methylene-3,5-di-tert-butyl-4-hydroxyhydrocinnamate)methane, i.e., Irganox 1010; 1,3,5-trimethyl-2,4,6-tris(3,5-di-tert-butyl-4-hydroxybenzyl)benzene, e.g., Ethanox 330; 1,3,5-tris(3,5-di-tert-butyl-4-hydroxybenzyl)isocyanurate, i.e., Good-rite 3114, 2,5-di-tert-amylhydroquinone, tert-butylhydroquinone, tris(nonylphenylphosphite), bis(2,4-di-tert-butyl)pentaerythritol)diphosphite, distearyl pentaerythritol diphosphite, phosphited phenols and bisphenols, such as Naugard 492, phosphite/phenolic antioxidant blends, such as Irganox B215; di-n-octadecyl(3,5-di-tert-butyl-4-hydroxybenzyl)phosphonate, such as Irganox 1093; 1,6-hexamethylene bis(3-(3,5-di-tert-butyl-4-hydroxyphenylpropionate), such as Irganox 259, and octadecyl-3,5-di-tert-butyl-4-hydroxyhydrocinnamate, i.e., Irganox 1076, tetrakis(2,4-di-tert-butylphenyl)4,4′-biphenylylenediphosphonite, diphenylamine, and 4,4′-diemthoxydiphenylamine, i.e. Ethanox 702. Such materials are normally employed at levels of about 0.05% to 5% based on the polymer, or 0.1% to 1% based on the polymer.

### 5. Reinforcements and Fillers

The processing methods listed and described in this invention are also suitable for the production of traditional composite and/or nanocomposite polymer parts, items, or articles by the use of one or more types of fillers or reinforcing components, which may be in the form of particles, filaments, powders, fibers, tubes, granules, strands, beads, or other uniform or nonuniform geometric shapes. Examples of reinforcing components and/or fillers include segments of fiberglass or chopped fiberglass, fiberglass cloth or woven roving, fiberglass mat, carbon or graphite fibers, organic fibers, aramid fibers, wood pulp, wood flour, ground or pulverized oyster shells, metals, aluminum powder or flakes, calcium carbonate, thermoplastic or elastomer reinforcements or fillers, silica, alumina, carbon black, silicates, aluminosilicates such as mica, talc, clays, sand, diatomaceous earth, volcanic glass or ash, Nanostructured™ Chemicals such as polyhedral oligomeric silsesquioxane (POSS™) based materials, vermiculite, asbestos, and calcium silicates, such as wollastonite. Some fillers or reinforcements may be surface treated with a silane coupling agent. The addition of fillers and/or reinforcements that have modified surface properties are particularly advantageous. The exact amount of a particular filler and/or reinforcement to be used in a particular situation or formulation will be easily determinable and will depend on the preferences of the practitioner. The addition of fillers and/or reinforcements may also serve to decrease the mold shrinkage of the final polymer product.

### 6. Impact Modifiers

In some embodiments of this invention, a preformed elastomer that is soluble in the reactant streams is added to the initiator system in order to increase the impact strength of the polymer or other mechanical properties, and to aid the moldability. An important factor in selecting an elastomer is in its ability to dissolve in the monomer. A short dissolution time may indicate that the elastomer is quite easily dissolved in the monomer. The addition of an elastomer can increase the polymer's impact strength 5-10 fold with only a slight decrease in flexural modulus. The elastomer is dissolved in either or both of the reactant streams in an amount from about 1 to about 15 weight percent, based on the weight of monomer. A concentration range for the elastomer is between about 3 and about 10 wt %. The elastomer can be dissolved in either or both of the polycyclic olefin streams in the 5-10 wt % range without causing an excessive increase in the solution viscosity. A target viscosity range at room temperature would about 100 to about 1000 cps or from about 200 to about 500 cps. The elastomer may be miscible with the polycyclic olefin monomer between 10° C. and 100° C. Suitable elastomers include, for example, natural rubber, butyl rubber, polyisoprene, polybutadiene, polyisobutylene, ethylene-propylene copolymer, styrene-butadiene-styrene triblock rubber, random styrene-butadiene rubber, styrene-isoprene-styrene triblock rubber, ethylene-propylene-diene terpolymers, ethylene-vinyl acetate and nitrile rubbers. Elastomers may include without limitation polybutadiene Diene 55AC10 (Firestone), polybutadiene Diene 55AM5 (Firestone), EPDM Buna T9650 (Bayer), Polysar Butyl 301 (Bayer), polybutadiene Taktene 710 (Bayer), Ethylene-Octene Engage 8150 (DuPont-Dow), styrene-butadiene Kraton D1184 (Shell), EPDM Nordel 1070 (DuPont-Dow), and polyisobutylene Vistanex MML-140 (Exxon). Various polar elastomers can also be used. The amount of elastomer used is determined by its molecular weight and is limited by the viscosity of the resultant streams. The streams cannot be so viscous that adequate mixing is not possible. The Brookfield viscosity of polycyclic olefins are between about 5 to about 10 cps at 35° C. Increasing the viscosity to between about 100 cps to about 1000 cps alters the mold filling characteristics of the combined streams. An increase in viscosity reduces leakage from the mold and simplifies the use of fillers by decreasing the settling rates of the solids. Although the elastomer can be dissolved in one or more of the streams it is required to ensure that all the two streams have similar viscosity so uniform mixing is obtained.

As an alternative, preformed elastomers that are essentially insoluble in the reactant streams can also be used to improve impact resistance of ROMP and addition-polymerized norbornene monomers. Core shell polymer particles can be defined as polymer particles have a core and a shell having different physical and/or chemical properties. With elastomeric core-shell particles it is meant that at least the core of the particles consists of elastomeric material. Elastomeric core-shell polymer particles have found use in stabilizing the impact properties of molded thermoset polymers of cycloolefins, such as ROMP DCPD polymers, as disclosed in PCT Publication No. WO 94/19385, the contents of each of which is included herein by reference in its entirety including the contents of all cited references, including without limitation U.S. Patent Documents, Foreign Patent Documents, and other publications. Elastomeric core-shell particles of a size not exceeding about 2 μm are dispersed in the starting monomers in an amount of from about 0.5 to about 20 weight percent relative to the weight of the monomer. Elastomeric core-shell particle having a size in the range of from about 0.01 to about 2 μm or in the range of from about 0.1 to about 1 μm. Examples of elastomeric core-shell particles suitable for use in the present invention are those marketed under their trademark PARALOID EXL, and in particular the PARALOID EXL2300/3300 elastomeric core-shell polymer series and/or the PARALOID EXL2600/3600 elastomeric core-shell polymer series and/or the PARALOID KM elastomeric core-shell polymer series and/or the PARALOID BTA elastomeric core-shell polymer series.

### Monomers

A wide range of norbornene-type monomers may be used in the present invention for the preparation of a wide range of polymers comprised of polymerized cyclic and linear repeating units. These cyclic olefin based polymers may be prepared by the ring-opening metathesis polymerization or addition polymerization or cationic polymerization or radical polymerization reaction(s) that occur when one or more reactant streams are combined to form a reactive mixture or composition. If one reactant stream is used that reactant stream must contain at least one norbornene-type monomer and may contain at least one ruthenium or osmium or molybdenum or tungsten initiator or catalyst and may contain one or more additional system components. If more than one reactant stream is used at least one of the reactant streams must contain at least one norbornene-type monomer, at least one of the reactant streams may contain at least one ruthenium or osmium or molybdenum or tungsten catalyst and one or more of the reactant streams may contain one or more additional system components. The norbornene-type monomer(s) can be polymerized via solution or mass/bulk polymerization techniques.

Cyclic olefins are those simple olefins, such as cyclopropene, cyclobutene, cyclopentene, methylcyclopentene, cycloheptene, cyclooctene, 5-acetoxycyclooctene, 5-hydroxycyclooctene, cyclooctadiene, cyclotetraene, cyclodecene, and cyclododecene.

As stated herein the terms “polycycloolefin,” “polycyclic”, and “norbornene-type” monomer are used interchangeably and mean that the monomer contains at least one norbornene moiety as shown below:

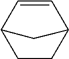

The simplest polycyclic monomer of the invention is the bicyclic monomer, bicyclo[2.2.1]hept-2-ene, commonly referred to as norbornene. The term norbornene-type monomer is meant to include norbornene, substituted norbornene(s), and any substituted and unsubstituted higher cyclic derivatives thereof so long as the monomer contains at least one norbornene or substituted norbornene moiety. The substituted norbornenes and higher cyclic derivatives thereof contain a pendant hydrocarbyl substituent(s) or a pendant functional substituent(s). The norbornene-type monomers are represented by the structure below:

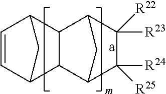

wherein “a” represents a single or double bond, R²² to R²⁵ independently represents a hydrocarbyl or functional substituent, m is an integer from 0 to 5, and when “a” is a double bond one of R²², R²³ and one of R²⁴, R²⁵ is not present.

When the substituent is a hydrocarbyl group, halohydrocarbyl, or perhalocarbyl group R²² to R²⁵ independently represent hydrocarbyl, halogenated hydrocarbyl and perhalogenated hydrocarbyl groups selected from hydrogen, linear and branched C₁-C₁₀ alkyl, linear and branched, C₂-C₁₀ alkenyl, linear and branched C₂-C₁₀ alkynyl, C₄-C₁₂ cycloalkyl, C₄-C₁₂ cycloalkenyl, C₆-C₁₂ aryl, and C₇-C₂₄ aralkyl, R²² and R²³ or R²⁴ and R²⁵ can be taken together to represent a C₁-C₁₀ alkylidenyl group. Representative alkyl groups include but are not limited to methyl, ethyl, propyl, isopropyl, butyl, isobutyl, sec-butyl, tert-butyl, pentyl, neopentyl, hexyl, heptyl, octyl, nonyl, and decyl. Representative alkenyl groups include but are not limited to vinyl, allyl, butenyl, and cyclohexenyl. Representative alkynyl groups include but are not limited to ethynyl, 1-propynyl, 2-propynyl, 1-butynyl, and 2-butynyl. Representative cycloalkyl groups include but are not limited to cyclopentyl, cyclohexyl, and cyclooctyl substituents. Representative aryl groups include but are not limited to phenyl, naphthyl, and anthracenyl. Representative aralkyl groups include but are not limited to benzyl, and phenethyl. Representative alkylidenyl groups include methylidenyl, and ethylidenyl, groups.

The perhalohydrocarbyl groups may include perhalogenated phenyl and alkyl groups. The halogenated alkyl groups useful in the invention are linear or branched and have the formula C_{z}X′₂ₓ₊₁ wherein X″ is a halogen as set forth above and z is selected from an integer of 1 to 10. X″ may be fluorine. Perfluorinated substituents may include perfluorophenyl, perfluoromethyl, perfluoroethyl, perfluoropropyl, perfluorobutyl, and perfluorohexyl. In addition to the halogen substituents, the cycloalkyl, aryl, and aralkyl groups of the invention can be further substituted with linear and branched C₁-C₅ alkyl and haloalkyl groups, aryl groups and cycloalkyl groups.

When the pendant group(s) is a functional substituent, R²² to R²⁵ independently represent a radical selected from the group consisting of: —(CH₂)ₙC(O)OR²⁶, —(CH₂)ₙ—C(O)OR²⁶, —(CH₂)ₙ—OR²⁶, —(CH₂)ₙ—OC(O)R²⁶, —(CH₂)ₙ—C(O)R²⁶, —(CH₂)ₙ—OC(O)OR²⁶, —(CH₂)ₙSiR²⁶, —(CH₂)ₙSi(OR²⁶)₃, and —(CH₂)ₙC(O)OR²⁷, wherein n independently represents an integer from 0 to 10 and R²⁶ independently represents hydrogen, linear and branched C₁-C₁₀ alkyl, linear and branched, C₂-C₁₀ alkenyl, linear and branched C₂-C₁₀ alkynyl, C₅-C₁₂ cycloalkyl, C₆-C₁₄ aryl, and C₇-C₂₄ aralkyl. Representative hydrocarbyl groups set forth under the definition of R²⁶ are the same as those identified above under the definition of R²² to R²⁵. As set forth above under R²² to R²⁵, the hydrocarbyl groups defined under R²⁶ can be halogenated and perhalogenated. The R²⁷ radical represents a moiety selected from —C(CH₃)₃, —Si(CH₃)₃, —CH(R²⁸)OCH₂CH₃, —CH(R²⁸)OC(CH₃)₃ or the following cyclic groups:

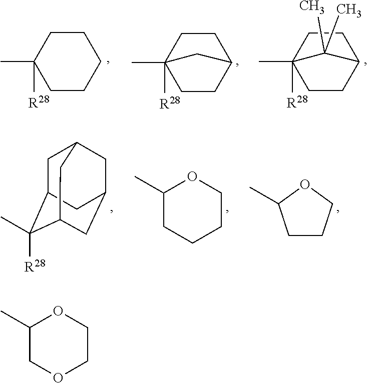

wherein R²⁸ represents hydrogen or a linear or branched (C₁-C₅) alkyl group. The alkyl groups include methyl, ethyl, propyl, i-propyl, butyl, i-butyl, t-butyl, pentyl, t-pentyl and neopentyl. In the above structures, the single bond line projecting from the cyclic groups indicates the position where the cyclic group is bonded to the acid substituent. Examples of R²⁷ radicals include 1-methyl-1-cyclohexyl, isobornyl, 2-methyl-2-isobornyl, 2-methyl-2-adamantyl, tetrahydrofuranyl, tetrahydropyranoyl, 3-oxocyclohexanonyl, mevalonic lactonyl, 1-ethoxyethyl, and 1-t-butoxy ethyl.

The R²⁷ radical can also represent dicyclopropylmethyl (Dcpm), and dimethylcyclopropylmethyl (Dmcp) groups, which are represented by the following structures:

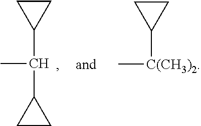

In the structure above, R²² to R²⁵ together with the two ring carbon atoms to which they are attached can represent a substituted or unsubstituted cycloaliphatic group containing 4 to 30 ring carbon atoms or a substituted or unsubstituted aryl group containing 6 to 18 ring carbon atoms or combinations thereof. The cycloaliphatic group can be monocyclic or polycyclic. When unsaturated the cyclic group can contain monounsaturation or multiunsaturation. When substituted, the rings contain monosubstitution or multisubstitution wherein the substituents are independently selected from hydrogen, linear and branched C₁-C₅ alkyl, linear and branched C₁-C₅ haloalkyl, linear and branched C₁-C₅ alkoxy, halogen, or combinations thereof. R²² to R²⁵ can be taken together to form the divalent bridging group, —C(O)-Q-(O)C—, which when taken together with the two ring carbon atoms to which they are attached form a pentacyclic ring, wherein Q represents an oxygen atom or the group N(R²⁹), and R²⁹ is selected from hydrogen, halogen, linear and branched C₁-C₁₀ alkyl, and C₆-C₁₈ aryl. A representative structure is shown below:

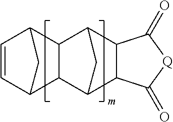

wherein m is an integer from 0 to 5.

Crosslinked polymers can be prepared by copolymerizing the norbornene-type monomer(s) set forth under Structure VII above with a multifunctional norbornene-type crosslinking monomer(s). By multifunctional norbornene-type crosslinking monomer is meant that the crosslinking monomer contains at least two norbornene-type moieties, each functionality being addition polymerizable in the presence of the catalyst system of the present invention. The crosslinkable monomers include fused multicyclic ring systems and linked multicyclic ring systems. Examples of fused crosslinkers are illustrated in structures below. For brevity, norbornadiene is included as a fused multicyclic crosslinker.

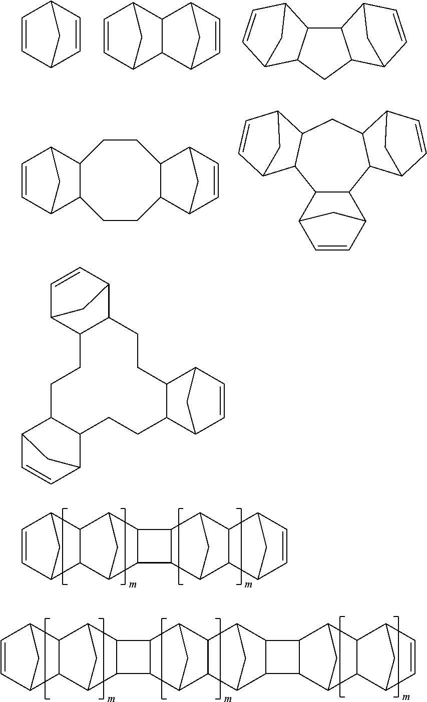

wherein m independently is an integer from 0 to 5.

A linked multicyclic crosslinker is illustrated generically in structure below.

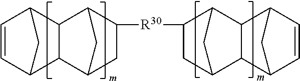

wherein m independently is an integer from 0 to 5, R³⁰ is a divalent radical selected from divalent hydrocarbyl and silyl radicals and divalent ether radicals. By divalent is meant that a free valence at each terminal end of the radical is attached to a norbornene-type moiety. Divalent hydrocarbyl radicals are alkylene radicals and divalent aromatic radicals. The alkylene radicals are represented by the formula —(C_{d}H_{2d})— where d represents the number of carbon atoms in the alkylene chain and is an integer from 1 to 10. The alkylene radicals selected from linear and branched (C₁-C₁₀) alkylene such as methylene, ethylene, propylene, butylene, pentylene, hexylene, heptylene, octylene, nonylene, and decylene. When branched alkylene radicals are contemplated, it is to be understood that a hydrogen atom in the alkylene backbone is replaced with a linear or branched (C₁ to C₅) alkyl group. Silyl radical can be selected from CH₂OSi(R)₂OCH₂, where R=methyl, ethyl, butyl, allyl, propyl, benzyl, or phenyl.

The divalent aromatic radicals are selected from divalent phenyl, and divalent naphthyl radicals. The divalent ether radicals are represented by the group —R³¹—O—R³¹—, wherein R³¹ independently is the same as R³⁰. Examples of specific linked multicyclic crosslinkers are represented as in Structures VIM to VIIIc as follows.

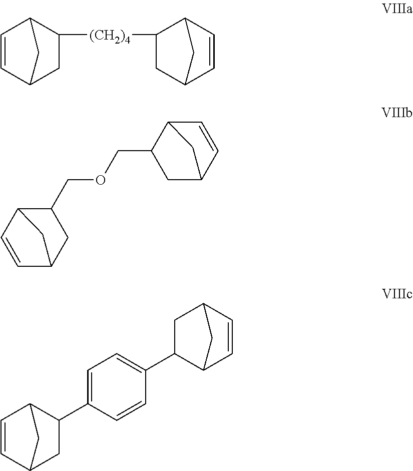

Examples of di and polyfunctional crosslinkable monomers include:

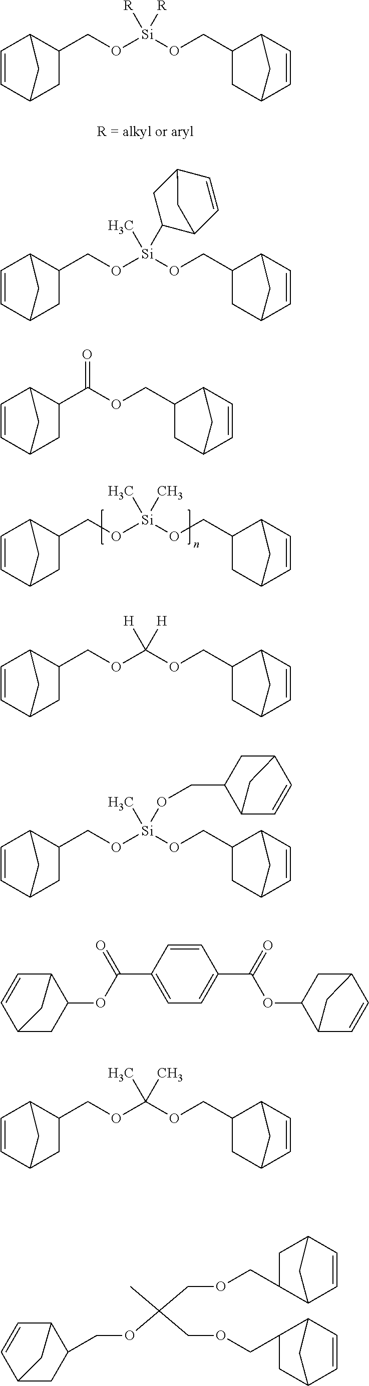

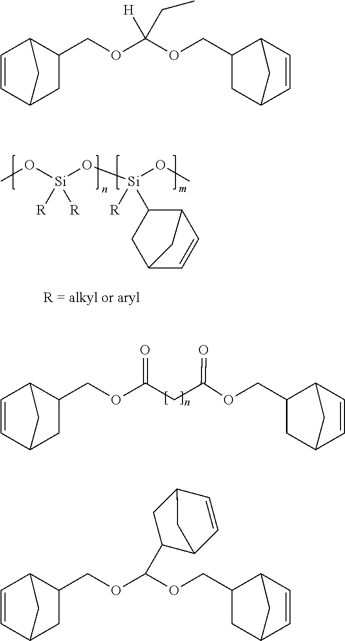

An economical route for the preparation of hydrocarbyl substituted and functionally substituted norbornene monomers relies on the Diels-Alder addition reaction in which CPD or substituted CPD is reacted with a suitable dienophile at elevated temperatures to form the substituted norbornene-type adduct generally shown by the following reaction scheme 13:

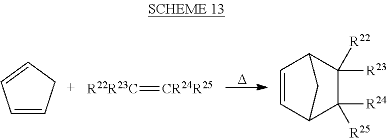

wherein R¹ to R⁴ independently represent hydrogen, hydrocarbyl, and/or a functional group as previously described.

Other norbornene type adducts can be prepared by the thermal pyrolysis of dicyclopentadiene (DCPD) in the presence of a suitable dienophile. The reaction proceeds by the initial pyrolysis of DCPD to CPD followed by the Diels-Alder addition of CPD and the dienophile to give the adducts shown below in Scheme 14:

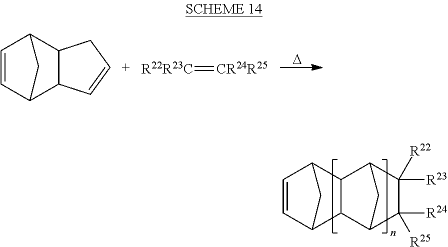

wherein n represents the number of cyclic units in the monomer and R²² to R²⁵ independently represent hydrogen, hydrocarbyl, and/or a functional group as previously defined. Norbornadiene and higher Diels-Alder adducts thereof similarly can be prepared by the thermal reaction of CPD and DCPD in the presence of an acetylenic reactant as shown below in Scheme 15:

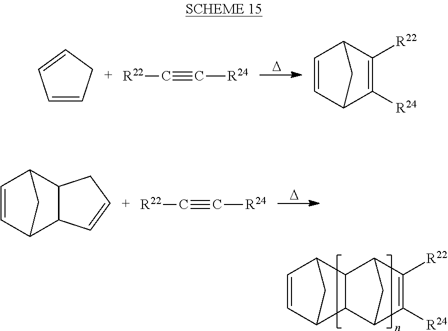

wherein n, R²² and R²⁴ are as defined above.

Norbornadiene may be employed as a crosslinker in this invention, however, higher homologs may be used. Norbornadiene can be converted into higher homologs or Diels-Alder products using a variety of dimerization catalysts or heating it with cyclopentadiene. In the case of the crosslinking monomer norbornadiene dimer an alternative synthesis is employed in which norbornadiene is coupled catalytically to yield a mixture of isomers of norbornadiene dimer as shown below:

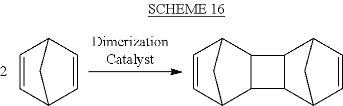

The dimerization of norbornadiene is easily achieved by numerous catalysts to yield a mixed composition of up to six isomers, as described in, for example, U.S. Pat. No. 5,545,790, the contents of each of which is included herein by reference in its entirety including the contents of all cited references, including without limitation U.S. Patent Documents, Foreign Patent Documents, and other publications. The isomers are the exo-trans-exo, endo-trans-endo, and exo-trans-endo-1,4,4a,4b,5,8,8a,8b-octahydro-1,4:5,8-dimethanobiphenylene (“norbornadiene dimer” or “[NBD]₂”). The exo-trans-exo norbornadiene dimer is a crosslinker. Heating norbornadiene dimer with dicyclopentadiene or cyclopentadiene can produce higher oligomers of norbornadiene dimer. Other crosslinkers are prepared by the reaction of cyclopentadiene with olefins containing two or more reactive olefins, e.g., cyclooctadiene, 1,5-hexadiene, 1,7-octadiene, and tricycloheptatriene.

The crosslinkable monomers are those containing two reactive norbornene type moieties. One monomer is 5,5′-(1,2-ethanediyl)bisbicyclo[2.2.1]hept-2-ene (NBCH₂CH₂NB) prepared by the reaction of 5-(3-butenyl)bicyclo[2.2.1]hept-2-ene and cyclopentadiene via a Diels-Alder reaction. The higher homolog of 5-(3-butenyl)bicyclo[2.2.1]hept-2-ene is also a co-monomer of choice, i.e., 2-(3-butenyl)-1,2,3,4,4a,5,8,8a-octahydro-1,4:5,8-dimethanonaphthalene. Similarly, 1,4,4a,5,6,6a,7,10,10a,11,12,12a-dodecahydro-1,4:7,10-dimethanodibenzo[a,e]cyclooctene is prepared in the Diels Alder reaction between 1,4,4a,5,6,9,10,10a-octahydro-1,4-methanobenzocyclooctene and cyclopentadiene. The higher homolog of between 1,4,4a,5,6,9,10,10a-octahydro-1,4-methanobenzocyclooctene is also a comonomer of choice, i.e., 1,4,4a,5,5a,6,7,10,11,11a,12,12a-dodecahydro-1,4:5,12-dimethanocycloocta[b]naphthalene. The symmetric and asymmetric trimers of cyclopentadiene are also useful crosslinking reagents, i.e., 4,4a,4b,5,8,8a,9,9a-octahydro-1,4:5,8-dimethano-1H-fluorene and 3a,4,4a,5,8,8a,9,9a-octahydro-4,9:5,8-dimethano-1H-benz[f]indene. Another monomer is obtained from the reaction of cyclopentadiene and norbornadiene, i.e., 1,4,4a,5,8,8a-hexahydro-1,4:5,8-dimethanonaphthalene. Divinylbenzene and excess cyclopentadiene forms the symmetric crosslinker 5,5′-(1,4-phenylene)bisbicyclo[2.2.1]hept-2-ene.

Examples of polymerizable norbornene-type monomers include but are not limited to, norbornene (bicyclo[2.2.1]hept-2-ene), 5-methyl-2-norbornene, ethylnorbornene, propylnorbornene, isopropylnorbornene, butylnorbornene, isobutylnorbornene, pentylnorbornene, hexylnorbornene, heptylnorbornene, octylnorbornene, decylnorbornene, dodecylnorbornene, octadecylnorbornene, p-tolylnorbornene, methylidene norbornene, phenylnorbornene, ethylidenenorbornene, vinylnorbornene, exo-dicyclopentadiene, endo-dicyclopentadiene, tetracyclododecene, methyltetracyclododecene, tetracyclododecadiene, dimethyltetracyclododecene, ethyltetracyclododecene, ethylidenyl tetracyclododecene, phenyltetracyclodecene, symmetrical and unsymmetrical trimers and tetramers of cyclopentadiene, 5,6-dimethylnorbornene, propenylnorbornene, 5,8-methylene-5a,8a-dihydrofluorene, cyclohexenylnorbornene, dimethanohexahydronaphthalene, endo,exo-5,6-dimethoxynorbornene, endo,endo-5,6-dimethoxynorbornene, 2,3-dimethoxynorbornadiene, 5,6-bis(chloromethyl)bicyclo[2.2.1]hept-2-ene, 5-tris(ethoxy)silylnorbornene, 2-dimethylsilylbicyclo[2.2.1]hepta-2,5-diene, 2,3-bistrifluoromethylbicyclo[2.2.1]hepta-2,5-diene, 5-fluoro-5-pentafluoroethyl-6-,6-bis(trifluoromethyl)bicyclo[2.2.1]hept-2-ene, 5,6-difluoro-5-heptatafluoroisopropyl-6-trifluoromethyl)bicyclo[2.2.1]hept-2-ene, 2,3,3,4,4,5,5,6-octafluorotricyclo[5.2.1.0]dec-8-ene, and 5-trifluoromethylbicyclo[2.2.1]hept-2-ene, 5,6-dimethyl-2-norbornene, 5-a-naphthyl-2-norbornene, 5,5-dimethyl-2-norbornene, 1,4,4a,9,9a,10-hexahydro-9,10[1′,2′]-benzeno-1,4-methanoanthracene. indanylnorbornene (i.e., 1,4,4,9-tetrahydro-1,4-methanofluorene, the reaction product of CPD and indene), 6,7,10,10-tetrahydro-7,10-methanofluoranthene (i.e., the reaction product of CPD with acenaphthalene), 1,4,4,9,9,10-hexahydro-9,10[1′,2′]-benzeno-1,4-methanoanthracene, endo,endo-5,6-dimethyl-2-norbornene, endo,exo-5,6-dimethyl-2-norbornene, exo,exo-5,6-dimethyl-2-norbornene, 1,4,4,5,6,9,10,13,14,14-decahydro-1,4-methanobenzocyclododecene (i.e., reaction product of CPD and 1,5,9-cyclododecatriene), 2,3,3,4,7,7-hexahydro-4,7-methano-1H-indene (i.e., reaction product of CPD and cyclopentene), 1,4,4,5,6,7,8,8-octahydro-1,4-methanonaphthalene (i.e., reaction product of CPD and cyclohexene), 1,4,4,5,6,7,8,9,10,10-decahydro-1,4-methanobenzocyclooctene (i.e., reaction product of CPD and cyclooctene), and 1,2,3,3,3,4,7,7,8,8,decahydro-4,7-methanocyclopent[a]indene.

Particularly useful monomers are those that contain more than one polymerizable double bonds because they are capable of releasing more energy but also because they can link polymer chains. The smallest polycyclic structure is norbornadiene, which has a carbon to polymerizable double bond ratio of 3.5, i.e., two double bonds per 7-carbons. These monomers are dimeric and trimeric crosslinking agents, and isomerized products of norbornadiene, i.e.,

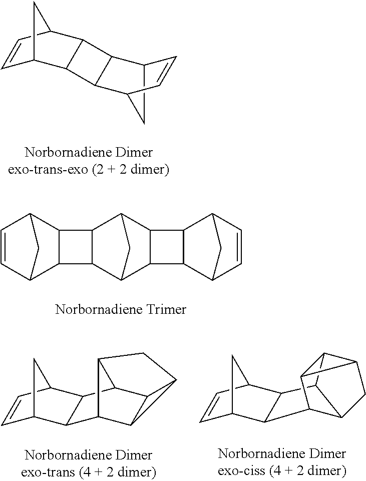

The cycloolefin monomers contemplated herein also include monomers disclosed in U.S. Pat. Nos. 4,301,306 and 4,324,717 the contents of each of which are included herein by reference in their entirety including the contents of all cited references, including without limitation U.S. Patent Documents, Foreign Patent Documents, and other publications. Both of these references disclose monomers that contain the norbornene structure depicted above.

The invention may also be used with a bulk polymerization process for “norbornene-type monomers,” which include norbornene, dicyclopentadiene, tricyclopentadiene (symmetrical and unsymmetrical cyclopentadiene trimer), tetracyclododecene and other cycloolefin monomers containing a norbornene functional group. Dicyclopentadiene is a common cycloolefin monomer used to prepare ring-opened metathesis polymerized polymers in that it is readily available as a by-product in ethylene production.

### Monomer to Initiator Reactant Ratio

The processing or molding of polymerizable monomers can be achieved using a monomer to initiator or catalyst (based on Ru or Os) molar ratio from about 100:1 to about 1,000,000:1, or from about 100:1 to about 500,000:1. The monomer to initiator molar ratio may be from about 1000:1 to about 100,000:1, or from about 5,000:1 to about 60,000:1.

### BRIEF DESCRIPTION OF THE DRAWINGS

FIG. 1 is an elevation view of a conventional aerial device depicting a vehicle, turntable, boom assembly, and platform.

FIG. 2 is an exploded view of a prior art aerial work platform assembly.

FIGS. 3A and 3B are assembled and exploded views, respectively, of an embodiment of an aerial work platform assembly in accordance with the invention.

FIGS. 4A and 4B are detail views of the mounting bracket subassembly.

FIGS. 5A and 5B are detail views of the valve bracket assembly and its construction.

FIG. 6 shows a magnified view of a preform material that may be used in the aerial work platform and aerial work platform components, as in FIG. 4B item 123.

### DETAILED DESCRIPTION OF EMBODIMENTS

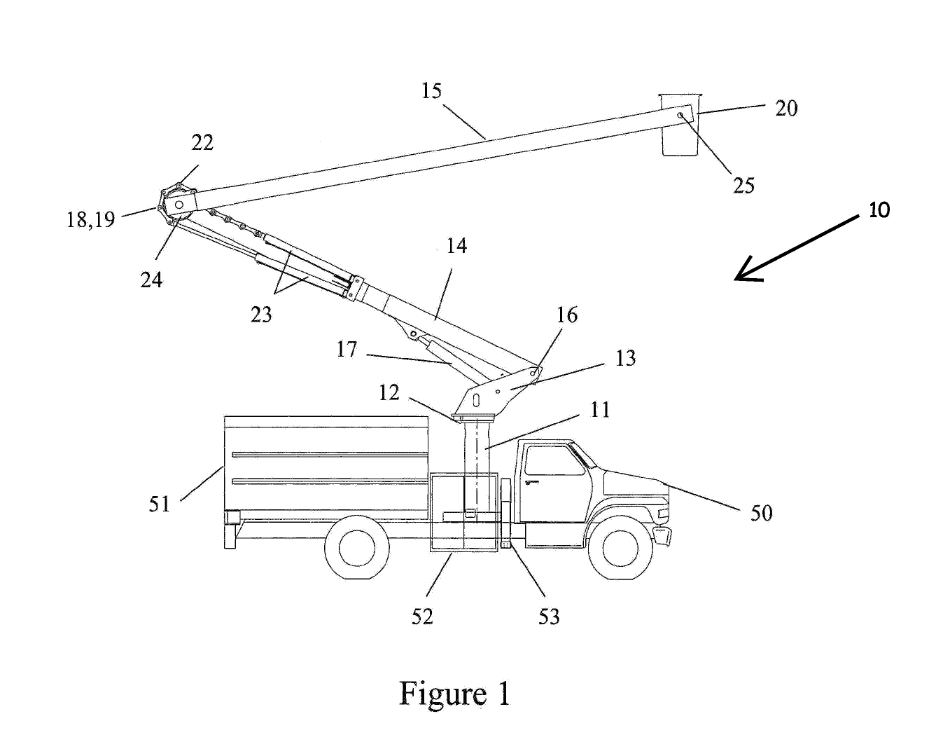

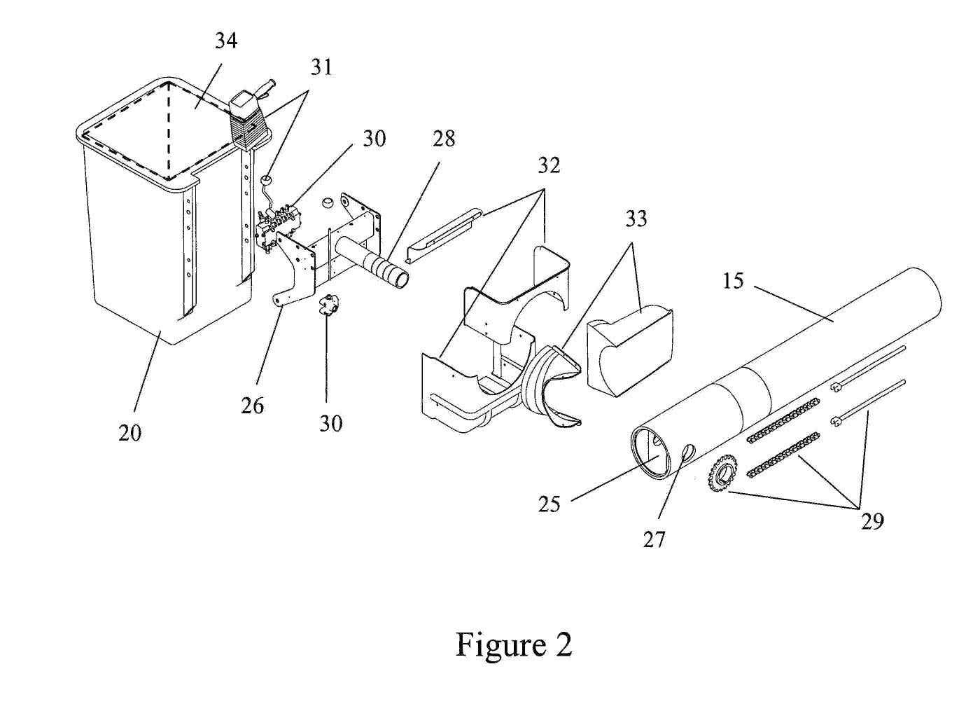

Certain features, which are used in assembling or operating the invention, but which are known to those of ordinary skill in the art and not bearing upon points of novelty, such as screws, bolts, nuts, welds, and other common fasteners, may not be shown for clarity. In order to appreciate the novelty of the present invention and its improvements over prior designs, a detailed description of the existing art is provided first with reference to FIGS. 1 and 2, followed by a description of various embodiments of the invention. The following description of FIGS. 1 and 2 focuses on one prior art configuration, particularly an over-center machine with an articulation linkage, with the understanding that many other variations of aerial configurations may be equally suitable for use with the invention including without limitation overcenter, non-overcenter, telescopic, and telescopic articulating.

Referring now to the drawings in more detail and specifically to FIG. 1, an articulating aerial device assembly 10 known in the prior art is mounted in the bed of a utility vehicle 50. A stationary pedestal 11 is mounted in the vehicle bed immediately behind the cab. Mounted for rotation on pedestal 11 is a rotation system 12, which supports a turntable 13. The turntable 13 can be rotated by a drive motor (not shown) about a vertical axis of rotation in order to rotate the aerial device 10 to various positions. Depending upon the specific function of the equipment, the vehicle 50 may also contain a chip box 51 and body bins 52.

The aerial device includes an articulating boom assembly formed by a lower boom 14 and an upper boom 15. The bottom end of the lower boom 14 is pivotally connected with the turntable 13 by a horizontal pin at the lower boom pivot 16. Lower boom 14 may be pivoted up and down about the axis of the lower boom pivot 16 by a hydraulic cylinder 17 having its base end pivoted to the turntable 13 and its rod end pivoted to a bracket on the lower boom 14.

The top end of the lower boom 14 is pivotally connected with the bottom end of the upper boom 15 at an articulated joint or elbow 18. A horizontal pivot shaft 19 forms a pivot axis about which the upper boom 15 can be articulated relative to the lower boom 14. Movement of the upper boom 15 relative to the lower boom 14 is accomplished by a drive link 22 operated by upper boom cylinders 23. The drive link 22 is engaged by an upper boom drive weldment 24, which functions as a sprocket, affixed to the base of upper boom 15, such that movement of the drive link 22 causes rotation of the upper boom drive weldment 24 and articulation of the upper boom 15. Upper boom 15 can pivot through a large angle of articulation relative to the lower boom 14. In a form of the present invention, this angle of articulation is well beyond 180 degrees and may approach 360 degrees. Further details of the articulating aerial device 10 and boom assembly are described in U.S. Pat. No. 4,602,462, the disclosure of which is incorporated herein by reference. At its top end or platform shaft retaining assembly 25, the upper boom 15 carries one or more aerial work platforms 20. A conventional leveling system (not shown) operates to maintain the platform 20 level to the ground at all positions of the lower and upper booms 14, 15.

The aerial device 10 has a storage position in which the lower and upper booms 14, 15 are side by side and horizontal. In the storage position, the lower boom 14 is lowered onto the truck 50. The upper boom 15 is lowered to a zero angle of articulation and rests on an upper boom rest (not shown) mounted on one side of the turntable 13. Optionally, a cab guard (not shown) may extend over the top of the cab to provide a convenient surface from which workers can enter or exit from the platform 20.

FIG. 2 provides an exploded view of a prior art aerial work platform assembly generally having a platform shaft retaining assembly 25 affixed to the upper boom 15, a mounting bracket 26, and a platform 20. The platform shaft retaining assembly 25 is typically constructed of steel or aluminum and contains bearings 27, which rotatably support a steel shaft 28 extending from a mounting bracket 26. Leveling system 29, comprised typically of a chain and sprocket system, is operatively connected to shaft 28 within platform shaft retaining assembly 25 to maintain the platform 20 level to the ground during use. One example of such a leveling system 29 is described in U.S. Pat. No. 5,944,138. the disclosure of which is incorporated herein by reference. Platform 20 is typically constructed from a fiberglass material and is connected to mounting bracket 26 by bolts or pins through the appropriate mating holes. Hydraulic control valves 30 and tool ports are attached, preferably by bolting, to the platform mounting bracket 26. Control handles 31 are connected to the hydraulic control valves 30 in a manner well known in the art, along with hydraulic hoses (not shown), which provide the hydraulic oil flow to and from the valves 30 to operate the upper and lower boom cylinders 17, 23. Various platform covers 32 are constructed from ABS plastic and are designed and positioned to shield the various metal components, such as the mounting bracket 26 and control valves 30, from contact with external objects. The mounting bracket 26 may also include a lanyard connection eyelet (not shown) to which workers may connect a safety lanyard while they are in the platform 20. As previously mentioned, the platform 20 usually requires a removable insulated liner 34 in order to provide a secondary layer of protection to the worker in the event an unexpected contact with unguarded electrical lines should occur. Note that the platform shaft retaining assembly 25 in FIG. 2 is designed to be reversible, such that the platform 20 and mounting bracket 26 may be installed on either side of the platform shaft retaining assembly 25, depending on the specific requirements at the time.

As can be appreciated from the foregoing description of the prior art, the use of metal components is extensive. Replacement of such parts with dielectric polymer materials or dielectric plastic parts or dielectric composite materials would provide many advantages. For example, polymer materials or plastic materials or composite materials are typically lightweight in comparison to steel. Lighter components require less counterweight at the vehicle, enable greater side reach of the boom and platform, and allow more capacity in the platform for workers and tools. Also, any reduction in weight would permit a size reduction in the leveling system and other mechanical systems, further saving production costs. Polymer materials or plastic materials or composite materials that can be designed to be nonconductive, would substantially reduce or eliminate potential electrical current paths within the aerial work platform assembly. Moreover, any covers that are required may possibly be designed as an integral part of the structural members employed in the improved assembly. Finally, required maintenance of parts is reduced due to the fact that polymer parts or plastic parts or composite parts do not rust.

However, there are a number of possible disadvantages to the use of polymer materials or plastic materials or composite materials. First, conservative engineering practice requires implementation of higher design safety factors than those associated with the use of ductile materials. Second, polymer materials or plastic materials or composite materials may require more complex part designs when trying to design complete components, as opposed to the simplicity of welding various metal parts to serve the same purpose. Further, the costs of polymer materials or plastic materials or composite materials, in terms of tool costs and ultimate part costs, are generally higher than steel. Finally, employment of polymer materials or plastic materials or composite materials to systems, which have traditionally been constructed from steel and aluminum may be resisted by industries and customers, which are slow to change from traditional methods and materials.

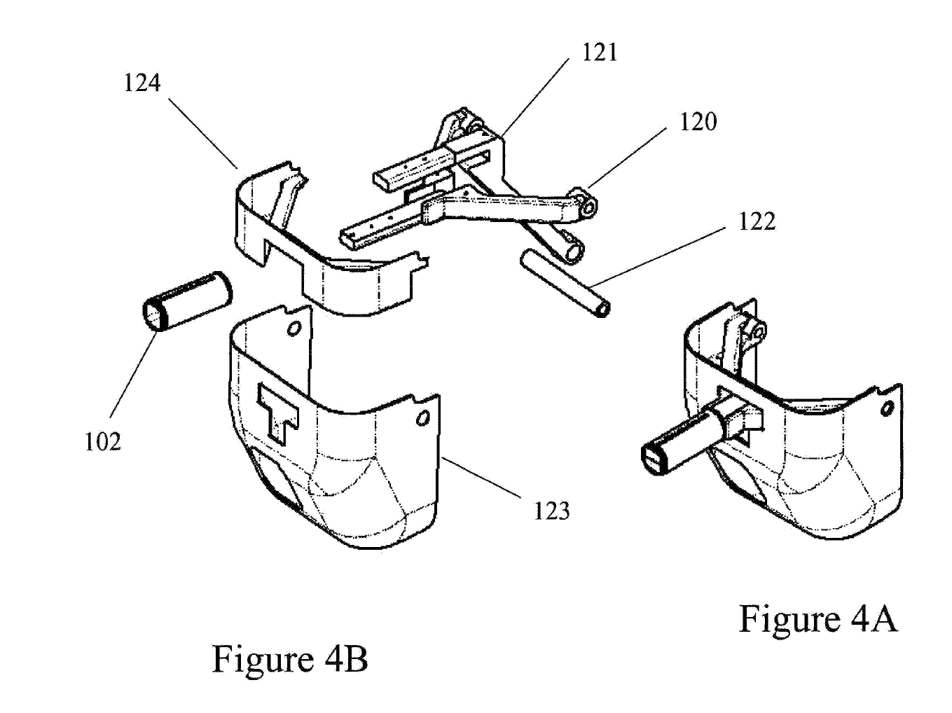

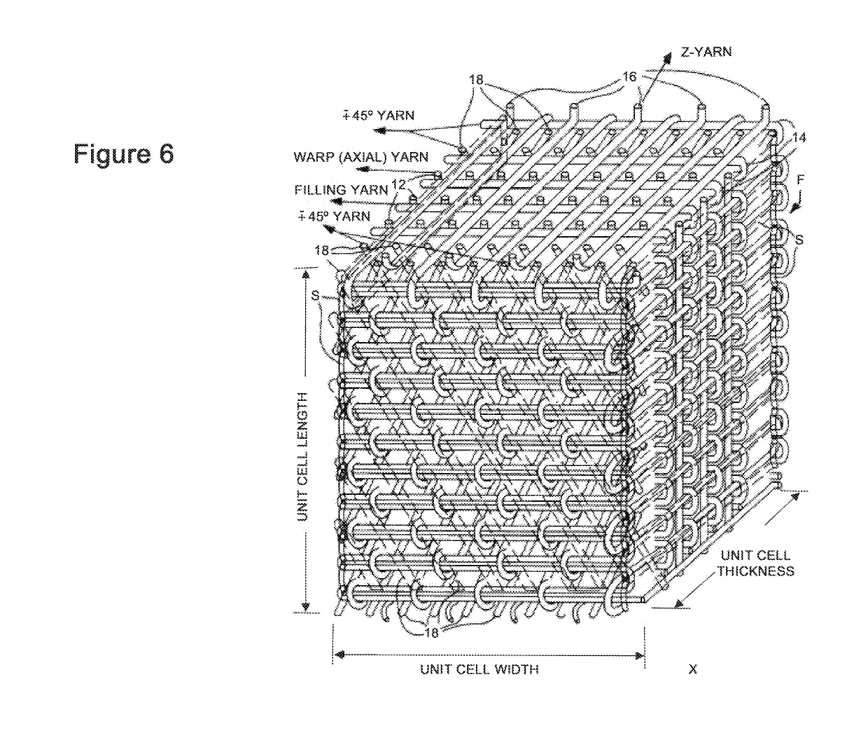

If it is determined that fiber reinforcements are desired with the resin matrix or polymer materials or plastic materials they may be used as below. By way of example, FIG. 6 shows a magnified view of a preform material that may be used in the components, as in FIG. 4B item 123. It illustrates one embodiment of a 3-D unitarily and integrally formed preform fabric, as set forth in U.S. Pat. No. 5,465,760, FIG. 1, which was incorporated by reference into the detailed description of the present invention hereinabove. The 3-D unitarily and integrally formed fiber fabric preform constructed by three (3) independent, interlacing non-crimped yarn systems, the preform providing for no delamination of the composite formed therefrom.

It is known in the prior art that composite materials may provide a superior combination of advantages when used in the fabrication of aerial work platforms and aerial work platform assembly components. As is known in the art, most “traditional” fiber-reinforced composites consist of a reinforcing fiber, such as fiberglass or Kevlar® and a surrounding matrix of polyester, vinyl ester, or epoxy resin. Those materials are normally formed by laminating several layers of textile fabric, by filament winding, or by cross laying of tapes of continuous filament fibers. However, those traditional laminated structures may suffer from a tendency toward delamination and ultimate failure. Consequently, efforts have been made to develop three-dimensional braided, woven, or knitted “preforms” as a solution to the delamination problems inherent in laminated composite structures. For example, U.S. Pat. Nos. 5,085,252 and 5,465,760, both of which are incorporated herein by reference, describe methods of forming variable cross-sectional shaped and multi-layer three-dimensional fabrics. Products embodying those methods are marketed under the trademarks “3WEAVE™” and “3BRAID™” by 3TEX, Inc., at http://www.3tex.com. When these types of preforms are used with various known resins, mechanical properties such as flexure (stiffness), tensile strength, compression strength, shear and others can be controlled. Moreover, the use of preforms, which embody such three-dimensional weaving methods, may provide more advantageous mechanical properties than the use of knitted fabric or woven roving, particularly with the non-conductive resins used, namely the resin marketed under the trademark Hydrex® by Reichhold Chemicals, Inc. The braided preforms, namely 3TEX's 3BRAID™ and 3WEAVE™ materials, have been found particularly suitable to the molding of parts that are complex and require a high degree of conformability and permeability of the fabric, as will be evident from the following description of the embodiments.

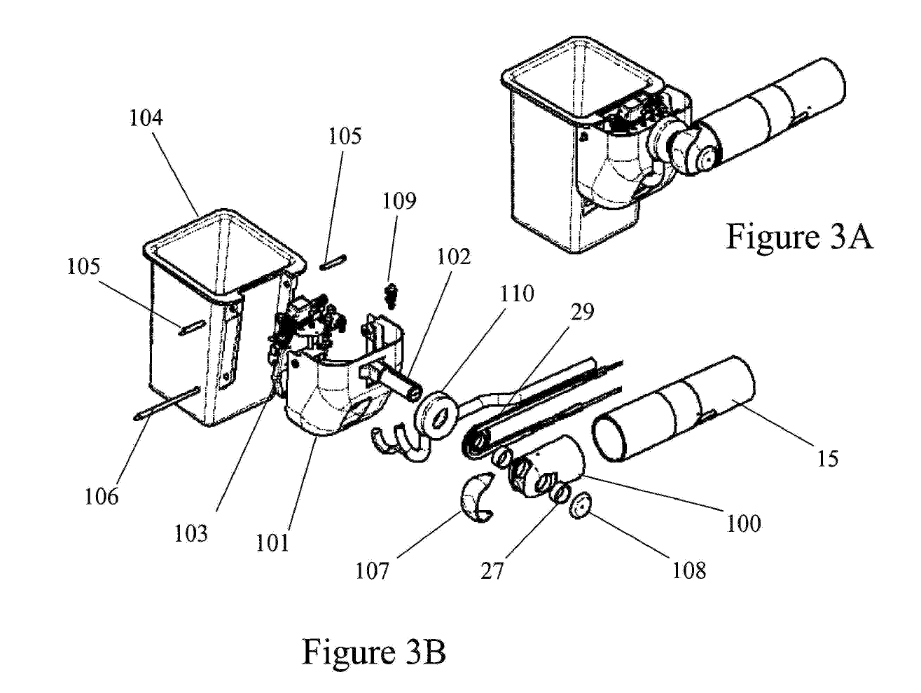

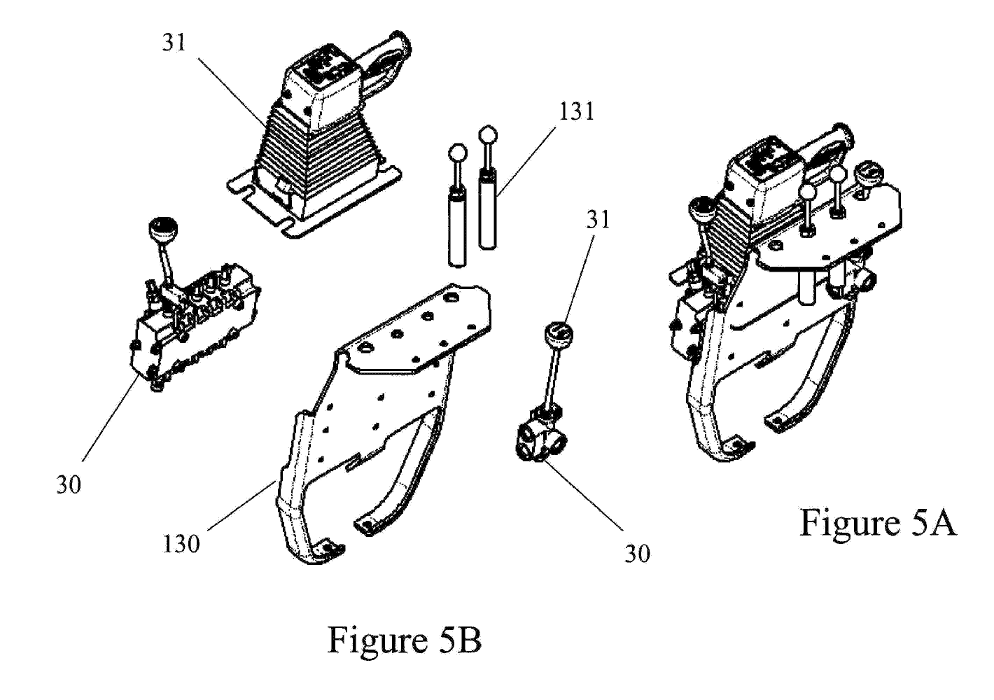

Referring to FIGS. 3A and 3B, assembled and exploded views, respectively, of an embodiment of the invention are illustrated. FIGS. 4A through 5B provide further detailed views of the subassemblies shown in FIGS. 3A and 3B. Although there may appear to be many similarities to the prior art in FIGS. 1 and 2, the present invention departs significantly in the following respects.

First, the invention includes a platform shaft retaining assembly 100 comprising a monomer having norbornene functionality, which is polymerized in a mold. The polymerized monomers having norbornene functionality, which are described in detail earlier herein, permit a more feature-rich design. The platform shaft retaining assembly 100 includes two concentric apertures for installation of a pivot shaft 102 extending from a redesigned platform mounting bracket 101. Platform shaft retaining assembly 100 further includes shaft bearings 27 and an end opening for allowing access to the leveling system 29. The end opening is readily covered during operation by an end cover 107.

As depicted more clearly in FIGS. 4A and 4B, mounting bracket 101 is fabricated by bonding or connecting two primary plastic or polymer or composite structures molded from monomers having norbornene functionality to one another, namely an upper gusset member 120 and a center gusset member 121, using any suitable adhesive or mechanical attachment. Center gusset member 121 and upper gusset member 120 also include horizontal portions to which pivot shaft 102 is bonded. Pivot shaft 102 is constructed from a steel or aluminum cylinder. Center gusset member 121 is also bonded to a lower tube 122, which attaches to a platform 104 by a lower platform pin 106, best shown in FIGS. 3A through 4B. Both upper gusset member 120 and center gusset member 121 are constructed from the aforementioned plastic or polymer or composite material molded from monomers having norbornene. Upper gusset member 120 has two horizontal arms that terminate in concentric bosses, through which two upper platform pins 105 are used to mount to the upper portion of platform 104. Platform bracket shroud 123 and platform bracket dashboard 124, as shown in FIG. 4B, are bonded onto the bracket assembly using any suitable adhesive or may be mechanically attached.

Platform 104 is also constructed from a plastic or polymer or composite material molded from monomers having norbornene functionality. Significantly, because of the superior properties of the plastic or polymer or composite material molded from monomers having norbornene functionality, the platform 104 is stronger, lighter, and more rigid than prior designs. Each of the platform pins 105 and 106 may be formed from a plastic or polymer or composite material molded from monomers having norbornene functionality, further isolating the platform 104 and worker from the possibility of electrocution. Platform 104 may also have one or more steps (not shown) integrally molded into one or more sides of the platform 104 or one or more steps (not shown) may be mechanically attached or adhesively attached to one or more sides of the platform 104. The steps (not shown) may be formed from a plastic or polymer or composite material molded from monomers having norbornene functionality. The steps (not shown) may be covered or affixed with a non-slip or non-skid surface.

Control valves 30, with their associated control handles 31, are assembled to a valve bracket 103 constructed from the aforementioned plastic or polymer or composite material molded from monomers having norbornene functionality and bolted to platform mounting bracket 101. Hydraulic hoses 110 are coupled in the ordinary manner to the control valves 30 and routed through upper boom 15 as in the prior art.

Platform bracket 101 also includes an upper open area for the passage of hydraulic hoses 110, 101. As described above, the interface between platform bracket 101 and platform 104 utilizes two upper platform pins 105 that can be easily removed to allow the platform 104 to pivot on the lower platform pin 106 and tilt down, thus allowing water and debris to be removed from the platform 104 and allowing maintenance access to the control valves 30.

As described above, various parts of the aerial work platform assembly of the present invention are molded from a monomer having a norbornene functionality, which is polymerized in a mold. For example, a reaction injection molding (RIM) process can be used to mold the parts. These parts include the platform shaft retaining assembly 100, the mounting bracket 101, the platform 104, the upper and lower platform pins 105, 106, and the valve bracket 103.

The monomer having norbornene functionality is described above and may include dicyclopentadiene; trimers, tetramers and higher order oligomers of cyclopentadiene; norbornene, hexylnorbornene, and other functionalized norbornenes; and mixtures thereof. The monomer may be polymerized in the mold with a metathesis catalyst comprising tungsten, molybdenum, or ruthenium. The monomer may have a pigment or color additive and/or a flame retardant incorporated therein. The surfaces of the molded parts may be coated with a primer or a primer and paint top coat.

As will become apparent to those of ordinary skill, the foregoing design features provide an array of advantages over prior art aerial devices, aerial technology, aerial work platforms, aerial work platform assemblies. First, with respect to insulation, because the resin used in the manufacture of the composite materials and components is non-conductive, all of the components constructed from such material enhance the electrical safety of the entire assembly.

Finally, the total costs of manufacturing the aerial work platforms and the aerial work platform assemblies can be reduced, and the ease of manufacture can be increased, because there is a corresponding decrease in required fabrication. Importantly, these trends are expected to improve as the number of aerial work platforms and aerial work platform assemblies manufactured increases over time.

Although exemplary embodiments of the present invention have been shown and described, many changes, modifications, and substitutions may be made by one having ordinary skill in the art without necessarily departing from the spirit and scope of the invention. For example, the present invention is not strictly limited to use with articulating or telescoping aerial devices such as those described herein. Any apparatus requiring the positioning of an operator within an electrically insulated platform could be improved by the addition of the aerial work platform assembly using a plastic or polymer or composite material molded from monomers having norbornene functionality as claimed, such as in the case of digger derricks. Also, it should be understood that any single component fabricated by a plastic or polymer or composite material molded from monomers having norbornene functionality, and which meets required structural criteria, would provide benefits to the entire boom assembly and is within the scope of this invention. Similarly, it should be understood that each or any of the aforementioned components, such as (by example only and not as an exhaustive list) the platform shaft retaining assembly 100, the mounting bracket 101, or the platform 104 may be constructed from different specifications of a plastic or polymer or composite material molded from monomers having norbornene functionality, depending upon the operating conditions to which they may be subjected.

1. A molded aerial work platform, comprising a monomer having norbornene functionality, which is polymerized in a mold.

2. The molded aerial work platform as in claim 1, wherein the monomer having norbornene functionality comprises dicyclopentadiene.

3. The molded aerial work platform as in claim 1, further comprising flame retardant additive.

4. The molded aerial work platform as in claim 1, wherein the monomer having norbornene functionality is polymerized in bulk with a metathesis catalyst comprising tungsten, molybdenum, or ruthenium.

5. The molded aerial work platform as in claim 1, wherein the monomer having norbornene functionality is selected from the group consisting of: dicyclopentadiene; trimers, tetramers and higher order oligomers of cyclopentadiene; norbornene, hexylnorbornene, and other functionalized norbornenes; and mixtures thereof.

6. The molded aerial work platform as in claim 1, further comprising fiber reinforcement.

7. The molded aerial work platform as in claim 1, wherein the surfaces of the aerial work platform are coated with (i) primer; or (ii) primer and paint top coat.

8. The molded aerial work platform as in claim 1, further comprising pigment or colorant additive incorporated therein.

9. The molded aerial work platform as in claim 1, wherein the platform is molded using a reaction injection molding (RIM) process.

10. The molded aerial work platform as in claim 1, wherein the platform comprises an aerial device mounted to a vehicle.

11. An aerial work platform assembly, comprising: a) a platform shaft retaining assembly; b) a mounting bracket connected to said platform shaft retaining assembly; and c) a platform connected to said mounting bracket; wherein said platform shaft retaining assembly includes two concentric apertures for installation of a pivot shaft therein; the mounting bracket having an upper gusset member and a center gusset member that are bonded together and that include horizontal portions to which the pivot shaft is bonded; upper and lower platform pins; a valve bracket; a platform bracket; and upper platform pins that provide for pivoting on a lower platform pin and tilting down of the platform thereby, and wherein at least one of the platform shaft retaining assembly, the mounting bracket, the platform, the upper and lower platform pins, and the valve bracket are molded from a monomer having at least one norbornene functionality.

12. The assembly of claim 11, wherein said mounting bracket is molded from a monomer having at least one norbornene functionality.

13. The assembly of claim 11, wherein said platform is molded from a monomer having at least one norbornene functionality.

14. The assembly of claim 11, wherein the platform shaft retaining assembly, the mounting bracket, the platform, the upper and lower platform pins, and the valve bracket are all molded from the same or differing materials comprising a monomer having at least one norbornene functionality.

15. The assembly of claim 11, further comprising fiber reinforcement.

16. The assembly of claim 11, wherein the monomer having norbornene functionality is selected from dicyclopentadiene; trimers, tetramers and higher order oligomers of cyclopentadiene; norbornene, hexylnorbornene, and other functionalized norbornenes; and mixtures thereof.

17. The assembly of claim 11, wherein the monomer having norbornene functionality is polymerized with a metathesis catalyst comprising tungsten, molybdenum, or ruthenium.

18. The assembly of claim 11, wherein the surfaces of the assembly are coated with (i) primer; or (ii) primer and paint top coat.

19. The assembly of claim 11, wherein the monomer having norbornene functionality further comprises a pigment or colorant additive incorporated therein.

20. The assembly of claim 11, further comprising a flame retardant additive.

21. The assembly of claim 11, wherein the assembly is molded using a reaction injection molding (RIM) process.

22. The assembly of claim 11, wherein the assembly comprises an aerial device mounted to a vehicle.
